(19) United States
(12) Patent Application Publication
(10) Pub. No.: US 2011/0208565 A1
(43) Pub. Date: Aug. 25, 2011

(54) COMPLEX PROCESS MANAGEMENT

(76) Inventors: Michael Ross, London (GB); Andrew McGregor, London (GB); Barry Wyse, London (GB)

(21) Appl. No.: 13/033,104

(22) Filed: Feb. 23, 2011

Related U.S. Application Data
(60) Provisional application No. 61/307,283, filed on Feb. 23, 2010.

(51) Int. Cl. G06Q 10/00

(52) U.S. Cl. 705/7.38

(57) ABSTRACT

The present invention relates to a computer implemented method and system for determining the source of a determined performance variance of a complex entity, and determining one or more different actions to be taken as a consequence of the determined source of performance variance.

### RELATED APPLICATIONS

This application relates to U.S. provisional application No. 61/307,283, entitled “IMPROVEMENTS RELATING TO COMPLEX PROCESS MANAGEMENT,” filed Feb. 23, 2010, invented by Michael Ross, Andrew McGregor, and Barry Wyse, and which is expressly incorporated herein by reference in its entirety for all purposes.

### FIELD OF THE INVENTION

The present invention concerns improvements relating to complex process management and more specifically, though not exclusively to a computer-implemented process suitable for analysing the performance of an e-commerce retail enterprise with respect to a desired overall objective to be achieved, and determining any required actions to rectify any identified underperformance or maintain/improve good performance.

### BACKGROUND TO THE INVENTION

There are many complex processes which require management to achieve a particular goal. Such management is particularly important when the number of variables becomes particularly high. Examples of such management can relate to assessment of the performance of an e-commerce enterprise. An e-commerce enterprise comprises a website used for e-commerce. In such systems the degree of complexity can significantly increase as the number of variables can be in the order of hundreds and/or thousands, generating millions of data points.

The present invention is described in the context of a computer-implemented e-commerce retail management system, which is a system for analysing data generated from an e-commerce platform relating to an e-commerce enterprise. An e-commerce platform is the set of integrated technology components required to run an e-commerce enterprise, and may relate to any online retail system, comprising both on-line components (such as a website) and off-line components such as warehousing systems, which are required in combination to provide the necessary retail services. It is to be appreciated that the present invention is not limited to application in the e-commerce enterprise environment. The present invention can be used to analyse the performance of any system where a complex management/control process is being executed to provide a quantitative analysis of the performance of the system, and to provide positive feedback to identify specific areas where the management/control process can be improved to better achieve a desired objective. The primary requirement of any such system is that data for determining whether the objective has been achieved (for example trading profit) is available to the system. For example, the present invention may be used with any online commerce application. Financial services and/or gaming are further non-limiting examples of the applications wherein the present invention may be used.

Various e-commerce platforms have been around for some time now and have been gaining in their appeal and complexity of offering. In part this is because the potential customer base of an e-commerce retail store is not restricted by geographical location, as is the case for traditional highstreet retail stores, also commonly referred to as brick and mortar retailers. The potential profitability of an online retail store is significantly greater than its more traditional brick and mortar counterpart. Amazon.com® is an example of a successful well known e-commerce retail enterprise, having a 2010 US market cap second only to Walmart™.

All e-commerce platforms comprise some form of native data analytics capability, which monitors and records data relating to its performance for management purposes. The different component systems comprised within an e-commerce platform may relate to marketing, product, customer services, and logistics (this is by no means an exclusive list of the different component systems comprised in an e-commerce enterprise). In turn, each component system may further comprise one or more sub-component systems. For example, the marketing component system may further comprise (this list is also non-exhaustive) sub-components for managing e-mail, search functionality, affiliates, customers, and campaigns. The product component system may comprise sub-components for reporting on pricing, inventory levels, promotions, product descriptions and images associated with the products. Similarly, the customer services component system may have sub-components to provide and manage customer records, contact history, issue resolution and customer service level reporting.

The native data analytics functionality of the different components of the e-commerce platform, hereinafter referred to as a ‘Default System’ in the ensuing description, generate high-level data relating to each of the different e-commerce platform components. Due to the cursory and disjointed nature of the generated data, only a superficial and disjointed overview of the performance of a specific component system is obtainable—a complete, holistic overview of the performance of the e-commerce enterprise is not provided for. Furthermore, this data is often generated using standardised reporting functions and has a very low resolution. There is no facility to query the gathered data for greater detail if required.

The practical utility of such ‘default’ systems in aiding a management process is limited, in part because of the lack of any holistic performance model, able to provide a detailed, accurate, and quantifiable measure of the overall performance of the e-commerce enterprise, on the basis of data generated by its component systems. This deficiency of the known prior art systems is accentuated in e-commerce enterprise having more complex e-commerce platforms. The resultant effect is that management or control decisions are typically based on human intuition and experience, loosely justified on the basis of available generic analytics data.

Recently, there has been a trend to adopt a more ‘scientific’ or empirical methodology to the e-commerce enterprise management process, by seeking more detailed analytics data to support the management control process. To this end, often one or more specialised component analytics systems are used. Each specialised analytics system exclusively generates and analyses data specific to a different e-commerce platform component, using general business analysis tools. By using a plurality of different specialised analytics systems, very detailed data relating to the performance of the e-commerce enterprise may be generated. Additionally, the generated data may be queried to conduct fine resolution analysis of a given component. For example, a marketing analytics system may be used to monitor and generate marketing-related data, whereas a specialised inventory monitoring analytics system will be used to monitor and generate inventory-related data, by monitoring product stock levels in a warehouse.

Despite the increased resolution of the data generated by such specialised analytics systems, there are still significant shortcomings. The generated data is still disjointed as it relates exclusively to the individual enterprise component and/or business area being analysed. No provision is made for aggregating the generated data together to provide a cumulative, holistic analysis of the performance of the e-commerce enterprise. Significant expertise and intuition is required of the user to interpret the significance of the generated data, and to relate the data to a desired objective. Furthermore, enormous volumes of data points, related to each specific component system are generated by each of the plurality of specialised analytics systems. The data is manipulated and mapped into an accessible format to generate quantified performance indicators, which may be consulted and used in a management decision-making process, and/or in a control process. The amount of data that is generated is proportional to the number of different components under analysis, and the problem of data handling increases with an increase in the number of components.

It is desired to overcome at least some of the above described problems and provide a method of enabling control of a complex process which is easy to control whilst at the same time provides a complete solution to meeting the overall objective.

### SUMMARY OF THE INVENTION

The present inventors have appreciated that one of the shortcomings shared by all e-commerce prior art systems, is the lack of an understanding of the relationship between data generated by the different specific e-commerce platform system components. This shortcoming precludes such systems from being capable of providing any constructive feedback regarding how a defined objective may be realised, and severely limits their practical utility.

More specifically, in the example of an e-commerce enterprise, there are five specific areas of activity, namely marketing (for example, the use of adwords, and other means for driving potential customers to the website), customer (for example information relating to the customer, such as geographical location, and purchase history), website activities (for example user interaction at the website in seeking to obtain products and services), optimising the product or service (for example having the correct range, managing the pricing and availability), and the operations following a successful interaction with the customer (for example, delivering the product/service to the customer). These areas cover the main processes of e-commerce.

The present inventors have appreciated that to assess the performance of an e-commerce enterprise and how it relates to a defined objective requires a holistic approach and an understanding of how the data generated by the different component systems is related, and how it contributes to the defined objective. In general, the relationship between generated data and achieving a desired objective, such as increasing profitability is not well understood in the prior art. For this reason, traditionally the performance measure of an e-commerce enterprise has focussed on an analysis of growth and sales, which are relatively straightforward to measure and understand, rather than profit, which is an absolute indicator of performance. No known prior art systems are capable of providing accurate measures of the absolute performance of an e-commerce enterprise.

One advantage of the enterprise management system of the presently claimed invention, is that a holistic analysis of the performance of an e-commerce enterprise is provided, on the basis of data received from the plurality of different component systems.

One of the difficulties with providing a holistic analysis of an e-commerce enterprise, is the significant mass of data generated by the process. For example, in the prior art e-commerce examples given above, marketing data is generated from search engines such as Google™, from affiliate programs and from marketing agencies. Analytics data is generated by monitoring all of the different types of possible user interaction occurring on the different pages of the website. Product data is generated from the availability/sales of each and every one of the different products being offered for sale, including their prices and range. Finally, data relating to the delivery of the products to the customer is provided including shipping times, costs and status as well as picking and packing issues and returns issues. This data is sent from various prior art systems and effectively overwhelms the operator of the e-commerce entity as they have difficulty in understanding and acting on this data, given its volume, complexity and disjointedness. Furthermore, for such complex and disjointed data to be of any practical utility in a management decision-making process, first requires analysis by very skilled specialists. The present invention addresses these problems by providing an automated solution.

Equally, the present invention stems from a realisation that in order to control all aspects of a process and to know the effects of changing a specific parameter of the process the Key Performance Indicators of the process need to be defined from a set of performance measures taken across the entire process, their relative relationships with other performance indicators needs to be understood and used to create a relationship framework and the value of each of the performance indicators needs to be realised in terms of the objective which is sought to be achieved.

The presently claimed invention addresses the aforementioned problems by adopting a holistic performance measure framework, which defines the quantitative relationships between different performance measures calculated from data generated by different components of an e-commerce enterprise. Furthermore, the present invention is able to handle large volumes of data, since the relationships between data and performance measures are well understood.

In the embodiments of the present invention set out below, an e-commerce process is described in which the objective is to maximise profit. However, in other processes, the value result which is sought to be optimised could be different. For example, in a portable computer manufacturing process with automated quality control, the objective may be to ensure production failures do not exceed a specified threshold value. Having determined this to be the objective, linking each of the multitude of performance indicators to its value in terms of this objective is one of the important parts of the present invention.

An advantage associated with the present invention is that a performance analysis of a complex entity such as an e-commerce enterprise may be automated. Similarly, the identification of any source of performance variance may also be automated, along with a quantitative measure of the impact the identified source may be having on the performance of the entity.

A further advantage associated with the present invention, is the automated generation of one or more actions required to improve or resolve an identified performance variance. Where the identified performance variance relates to a performance shortcoming, this may entail generating one or more actions required to resolve the identified performance shortcoming.

The present invention may advantageously also be used to retrospectively identify and quantify the impact an implemented action has had on the performance of an entity.

The present invention can also simulate the effect implementing an action may have on the performance of an entity.

### BRIEF DESCRIPTION OF THE DRAWINGS

FIG. 1 is a schematic block diagram showing an enterprise management system operatively connected to an e-commerce retail platform and third party analytics components, in accordance with the present invention;

FIG. 2 is a high-level overview of the method employed by the present invention;

FIG. 3 is a graphical illustration of a selection of the hierarchical performance measure framework;

FIG. 4 is a functional overview of the enterprise management server, and the storage device used in the system illustrated in FIG. 1;

FIG. 5 is a detailed process flow chart, outlining the performance analysis method step of FIG. 2;

FIG. 6a is a screenshot of the executive dashboard, providing an automated overview of the holistic performance of an e-commerce enterprise with regard to trading profit, in addition to providing information regarding the sources of performance variance, and proposed actions for rectifying identified underperformance to increase trading profit, in accordance with the present invention;

FIG. 6b is a screenshot of the marketing dashboard, providing an automated overview of the performance of the marketing component of an e-commerce enterprise, in addition to identifying the sources having the largest impact on marketing performance, and providing proposed actions for rectifying identified underperformance to improve the marketing performance of the e-commerce enterprise;

FIG. 7 is a detailed process flow chart, outlining the diagnosis method step of FIG. 2;

FIG. 8 is a screenshot of the impact analyser, providing a detailed breakdown of the different source data affecting trading profit, in accordance with the present invention; and

FIG. 9 is a detailed process flow chart, outlining the problem resolution method step of FIG. 2.

### DETAILED DESCRIPTION

The present invention relates to a management system for use in managing a complex entity. An e-commerce enterprise is an example of a complex entity, and the ensuing description of the present invention is described in relation to an e-commerce enterprise. Prior to discussing the best mode of operation of the present invention, and to aid the reader's understanding, a brief explanation of certain terms, which feature frequently in the present description is provided.

Use of the term ‘e-commerce dashboard’ in the present description refers to a graphical user interface (GUI) providing a visual summary of the state and/or performance of an e-commerce enterprise, and may be comprised within an enterprise management system. The dashboard may be interactive, enabling the user to control the displayed information. This visual summary often entails displaying several indicators of the state of an enterprise (i.e. the number of sales made in specified time period, the return on inventory, etc.). Equally, a dashboard may summarise the performance of a component of the e-commerce enterprise. This may be achieved by graphically displaying a selection of performance measures, including both KPIs and PIs, associated with the subject e-commerce enterprise component.

The enterprise management system of the present invention analyses source data generated by the enterprise and may use this data to determine one or more performance indicators indicative of the performance of the enterprise, or any selected business area of the enterprise. To achieve a holistic view of the performance of an enterprise, it is necessary to understand the relationship between the one or more different performance indicators, which individually may only provide an indication of the performance of a single business area, and how these performance measures may be associated with a holistic measure of the performance of an enterprise—such as trading profit.

An ‘e-commerce platform’ relates to the set of integrated technology components required to run an e-commerce enterprise, such as an online retail store. The platform tends to be comprised of several different components, each component relating to a different service/business area of the e-commerce enterprise, and may comprise analytics systems. The analytics systems may generate and record data relating to the specific service/business area it is associated with. For example, an order management component will generate data relating specifically to purchase orders, such as items ordered, order number, order time, order status, etc. The only common data element with other technology components may be order number. In contrast, a marketing component, will generate data for use in assessing the marketing performance of the e-commerce enterprise. Turning to the example of an online retail store, such data may relate to the source of a web user's visit, for example was the user directed to the retail website via a Google™ search, or was the website bookmarked in the user's browser? Such information is extremely important, insofar as it provides the retail management with a clear and precise indication of the make-up of the online retail websites traffic. On the basis of this information, online marketing campaigns may then be optimised to meet the online retail website's needs.

The number of different variables that an e-commerce enterprise manager can vary to affect performance are limited, and may in part be dependent on the subject e-commerce enterprise. In the present context, an ‘Action’ refers to any activity which a manager of a specific e-commerce enterprise may take to vary the performance of the e-commerce enterprise, by manipulating the available variables, also commonly referred to as ‘Levers.’ Actions offer a practical means of implementing selected objectives. Variation of one or more selected variables will have an effect on the performance of the e-commerce enterprise. Such effects may be retrospectively observed by monitoring the source data generated by the different analytics systems, as a result of the implemented variable manipulation. It follows that the effect of manipulating one or more selected variables may be quantifiable—or in other words, every action may be quantifiable. On this basis, it is also possible to simulate, predict and/or estimate the effect implementing a selected action will have on a selected objective. Since actions may be quantifiable, it is possible to predict which actions are required for realising a defined objective. In effect, the precedent set by carrying out a quantified analysis of the effect implementing a specific action has on the operation of an e-commerce enterprise, may be used to predict future effects implementing the same action may have on the e-commerce enterprise, with respect to a defined objective.

The e-commerce management system of the herein described embodiment may be physically separate to an e-commerce platform, yet it may be coupled, or otherwise operatively connected to the e-commerce platform, enabling the exchange of data between the system and the platform. As previously mentioned, the e-commerce platform may comprise several different analytics systems local to each different platform component. The principle function of an e-commerce management system is to collect and analyse source data generated directly by the e-commerce platform, including source data generated by any one of the different analytics systems comprised therein. This source data is subsequently used to generate performance measures, which are quantifiable measures, or metrics of the performance of the e-commerce enterprise.

Performance measures may be sub-divided into key performance indicators (KPI) and performance indicators (PI). KPIs are measures, and/or metrics providing a holistic view of the performance of an enterprise. For example, trading profit is a retail KPI. In contrast, PIs are measures and/or metrics providing an indication of the performance of a part of the enterprise. Taken in isolation. PIs are not sufficient to provide a holistic view of performance however, are nonetheless beneficial when assessing the performance of certain specific components of an enterprise. For example, conversion rate, which is a PI measure of the percentage of visitors to a retail website that purchase a product, provides only a limited indication of enterprise performance since the operating costs of the enterprise are not taken into consideration. Nonetheless, a low conversion rate may, for example be indicative of a poorly constructed website. Accordingly. PIs may still be useful in highlighting any performance issues associated with specific platform components. On the basis of an analysis of the performance measures, management advice and/or control process advice may be generated. Central to the present e-commerce enterprise management system is the requirement that source data relating to one or more of the different e-commerce enterprise components is generated and forwarded to the enterprise management system for analysis.

For an improved user experience, and in accordance with the herein described embodiment of the present invention, the e-commerce management system may comprise one or more e-commerce dashboards (described previously). In this way, a quick review by the user of the dashboard, will provide a clear indication of the performance of the e-commerce enterprise, or the selected e-commerce enterprise component. It is anticipated that the primary users of the herein described enterprise management system are likely to be online retail managers, responsible for the management of retail websites, and accordingly the dashboards are designed to convey information desirable to such users. The generated dashboards may be displayed as graphs, or any other type of suitable visual indicator.

The reader skilled in the art of retail management will appreciate that there exist many different performance measures, which may be used as indicators of the performance of the various different components comprised in an e-commerce retail enterprise. Given that such concepts are widely understood in the art, a detailed discussion will not ensue.

The following sets out a non-limiting example of an embodiment of the present invention. The embodiment relates to an e-commerce management system configured to receive source data from an e-commerce platform comprising one or more different analytics systems. The analytics systems may either be native to the e-commerce platform, or they may be third party analytics systems. The analytics systems are operatively coupled to each different e-commerce platform component. The objective of the e-commerce enterprise management system of the herein described embodiment, is increasing trading profit—in other words, the objective is to maximise trading profit. This is achieved by automating a management decision-making process, to determine one or more required actions that will increase trading profit, on the basis of an analysis of current enterprise performance. It is to be appreciated that the herein described e-commerce enterprise management system, may equally be used to maximise and/or realise other objectives.

Furthermore, the skilled reader will appreciate that the system and method of the herein described invention is not limited for use with an e-commerce enterprise, and may be used in any complex process requiring management and/or control to achieve a defined objective.

A plurality of different performance measures (including KPIs and PIs) exist which may be used to provide alternatively, a holistic or a partial indication of the performance of an e-commerce enterprise, and are widely known in the art. For example, marketing cost, conversion rate, and average order value, are all examples of commonly known measures used to assess performance. However, the relationship between different performance measures, such as the aforementioned, and how the different performance measures relate to a defined objective, is not always explicitly known. This is a significant shortcoming of prior art systems. In the context of an e-commerce enterprise, the precise relationship between different performance measures and trading profit, for example, is not well understood in the prior art. In part, this shortcoming underlines why prior art systems are unable to provide a holistic overview of e-commerce enterprise performance.

As mentioned briefly above, a plurality of different actions exist which a manager of an e-commerce enterprise may vary to affect the performance of the enterprise. Since, in the context of retail enterprise, the ultimate measure of performance is profitability, all further discussion of enterprise performance will be discussed in relation to trading profit. A plurality of actions exist which the manager of an e-commerce enterprise may vary to affect profit. Identifying the one or more relevant actions requiring implementation to increase profit, is an objective of the present e-commerce enterprise management system. It is not a trivial exercise to identify these actions. The difficulty is in part due to the large number of possible variables available, and the massive sets of data generated by the analytics systems, which require analysis to identify the sources of any potential underperformance in the e-commerce enterprise, such that performance may be improved, to increase trading profit. Identification of the sources directly affecting profitability is achievable once the relationship between received source data, performance measures, and available actions is established.

Identifying and implementing the one or more actions which will increase the profitability of an e-commerce enterprise requires a holistic approach. Specifically, it requires an understanding of how the different actions affect profitability. This may be achieved by understanding the relationship between available actions, and performance measures—specifically the trading profit KPI. In particular an understanding of how implementing any one action affects the performance of the e-commerce enterprise is required. In other words, it is important to understand and appreciate how implementing an action associated with one specific business area, may affect performance of another apparently unrelated business area—such an appreciation may only be developed by taking a holistic approach. Once such a relationship is understood, it is possible to prioritize required actions on the basis of the likely impact they will have on the selected objective, which in the following description of the best mode of operation of the invention is trading profit.

The below described embodiment allows a moderator, or manager of an e-commerce enterprise to identify any problems associated with currently implemented management processes, which may be adversely affecting profitability. This is achieved in part, by employing a detailed hierarchical performance measure relationship framework, which defines the causal relationships between different performance measures, and ultimately defines how the plurality of different performance measures relate to trading profit. Each performance measure is a function of either other performance measures or a function of specific source data generated by the one or more analytics systems. In other words, the hierarchical performance measure relationship framework defines the mathematical relationships between the different performance indicators and source data. For example, the lost sales PI, may be expressed as a sum of three different performance measures—namely, the sum of returned order value, declined order value, and cancelled order value. In turn, each of the aforementioned three measures is a direct function of source data.

Ultimately, the hierarchical performance measure relationship framework provides a means for establishing a relationship between generated performance measures, including trading profit and source data. Integrating such a hierarchical performance measure relationship framework into an e-commerce enterprise management system, facilitates the identification of underperformance, which may be attributable to implemented processes, and facilitates the identification of actions required to resolve the identified underperformance. Equally, the method of the present invention may be used to identify the source(s) of overperformance. This is particularly useful in a context where an e-commerce enterprise is performing better than expected however, an understanding of the underlying reasons for the performance is lacking.

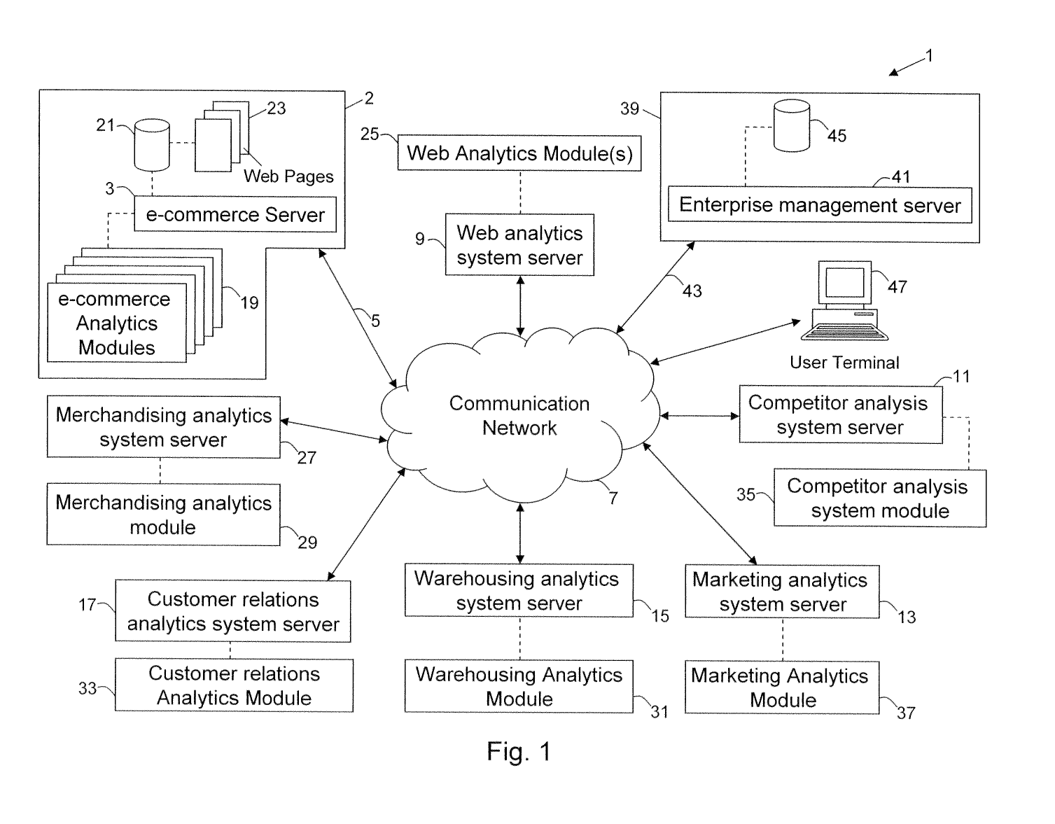

FIG. 1 is a general overview of a system 1 in accordance with the present invention. Specifically, FIG. 1 illustrates how an e-commerce enterprise 2 may be used with the present invention. An e-commerce enterprise may relate to any online retail entity, such as Amazon.com®, or any other online retailer. The skilled reader is reminded that the present invention is not limited to use with an e-commerce enterprise, and may be used in conjunction with any online commerce application, as mentioned previously. However, for illustrative purposes, the herein described preferred embodiment is described with respect to an e-commerce enterprise. The e-commerce enterprise 2 comprises an e-commerce server 3 provided with a communication channel 5 operatively connecting the e-commerce server 3 to a communications network 7, such as the internet. One or more third party analytics system servers (i.e. web analytics system server 9, competitor analysis system server 11, marketing analytics system server 13, warehousing analytics system server 15, customer relations analytics system server 17, merchandising analytics system server 27) may be operatively connected to the e-commerce server 3 via the shared communications network 7. In combination, the e-commerce server 3 and the different analytics systems form an e-commerce platform. Alternatively, and as mentioned previously, the functionality afforded by the third party analytics systems, discussed in further detail below, may be provided by one or more native analytics modules 19, native to the e-commerce server 3. In such alternative arrangements, the system 1 may not feature any third party analytics systems.

The e-commerce server 3 may comprise a data storage device 21, arranged to host and store data required to run a retail website. This may comprise storing data relating to one or more web pages 23. The e-commerce server's data storage 21 contains all the data required to run the online retail website, including data relating to content, and data relating to the graphical presentation of the content, which an e-commerce customer (not shown) interacts with directly via an internet browser running on a terminal (not shown) when navigating through the retail website. Although FIG. 1 only illustrates one e-commerce server 3, the skilled reader will appreciate that an online retail website may be physically hosted on a plurality of different e-commerce servers, and such alternative embodiments fall within the scope of the present invention. Additional examples of the type of data stored on the data storage device 21 are hyperlink data required to redirect a user to the appropriate webpage, and/or server (in those embodiments where the retail website may be hosted on more than one different physical server), on the basis of a received user request.

An e-commerce customer (not shown) accesses the e-commerce server 3 remotely via the shared communications network 7, using a terminal (not shown) running an internet browser, and navigates through the e-commerce website and optionally makes a purchase. The skilled reader will appreciate that at any one moment in time a plurality of e-commerce users (not shown) may be remotely navigating through the e-commerce enterprise's online retail website and purchasing advertised products. Accordingly, the e-commerce server 3 is equipped to handle a plurality of different remote connections originating from a plurality of different e-commerce customers (not shown).

The plurality of third party analytics systems, which may comprise servers 9, 11, 13, 15, 17, 27 comprised within the e-commerce platform, each provide specific analytical functionality. Each system records data relating to a particular enterprise business area, or equivalently to a different enterprise component comprised within the e-commerce enterprise. For example, in the present embodiment the different enterprise areas considered are marketing customer, product, operations, and site. To clarify, for management purposes, the e-commerce enterprise may be divided into the different, aforementioned enterprise areas. Each analytics system 9, 11, 13, 15, 17, 27 gathers and processes raw data relating to its allocated enterprise area. The raw data is generated by the e-commerce server 3 as users visit and interact with the online retail website. For example, every user visit to the retail website generates specific raw data, such as Internet Protocol (IP) address of the user, the products viewed, pages visited, whether any purchases were made, and how the user arrived at the retail website (i.e. through a Google™ search, or a bookmarked hyperlink). The aforementioned examples of raw data are non-limiting, and provide only a glimpse of the type of raw data generated by e-commerce server 3. The raw data is processed by the one or more analytics systems 9, 11, 13, 15, 17, 27 to generate analytics data, which may be used in assessing the relative performance of the specific enterprise area. It is important to note that whilst the analytics systems generate analytics data relating to their specific assigned business areas, such analytics data may be used to generate a holistic analysis of the enterprise's performance.

Analytics data may be continuously generated, recorded, processed and aggregated for use in assessing the performance of the e-commerce enterprise. The functionality provided by the plurality of analytics systems 9, 11, 13, 15, 17, 27 may be provided by third party analytics systems, and/or may be provided by one or more modules 19 native to, and comprised within the e-commerce server 3. In embodiments featuring one or more different third party analytics servers 9, 11, 13, 15, 17, 27, if required the servers 9, 11, 13, 15, 17, 27 may be configured to communicate with each other. In this way, data may be exchanged between the different analytics server 9, 11, 13, 15, 17, 27 if required for the purposes of generating specific analytics data. The skilled reader will appreciate that the functionality of the depicted analytics servers 9. 11, 13, 15, 17, 27 and/or modules 19 may be provided by one or more hardware and/or software components.

The e-commerce analytics systems illustrated in FIG. 1 may comprise web analytic server 9, comprising a web analytics module 25 providing the server with the required analytics functionality. Similarly, the competitor analysis system server 11, may be provided with a competitor analysis system module 35 providing the server 11 with the required analytical functionality. Marketing analytics system server 13, may be provided with marketing analytics module 37 providing the server 13 with the required analytical functionality. Likewise, warehousing analytics system server 15 may be provided with warehousing analytics module 31, customer relations analytics system server 17 may be provided with customer relations analytics module 33 and merchandising analytics system server 27 may be provided with merchandising analytics module 29. The provided examples are for illustrative purposes only and are non-exhaustive. Depending on the configuration of the particular e-commerce platform, different analytics systems (not shown) may be employed.

Each analytics system may record raw data relating to specific enterprise business areas, and generates analytics data associated with the subject enterprise business area. This analytics data may provide some insight into the performance of the e-commerce enterprise. For example, the web analytics system server 9 may record data relating to a user's activities on the retail website, such as the path and pages a user navigates before exiting the site; actions completed on the site, such as viewing product, adding products to a shopping basket, and making a purchase. As mentioned previously, this raw data may then be used to generate analytics data, for example such as the total number of customers visiting the website; the total number of customers making a purchase; the bounce rate (i.e. a measure of the percentage of users that leave the website after looking at only one webpage); the number of customers purchasing a particular product. The web analytics system 9 may also record error pages and broken links on the site. Omniture®, Coremetrics®, Webtrends®, Google Analytics™ are all examples of commercially available web analytics systems.

The merchandising analytics system server 27 may measure data relating to the specification of all goods and/or products offered or sold by the e-commerce enterprise, via the online retail website, and may include for example, recording and generating analytics data related to total sales, product costs, total inventory and products on back order. Commercially available merchandising systems include: Navision™, Island Pacific™ and SAP™.

Marketing analytics systems 11 may comprise recording and generating analytics data relating to any marketing activities and campaigns implemented by the e-commerce enterprise to attract users to the e-commerce retail website. Non-limiting examples of commercially available marketing systems include: Kenshoo Search™, Google Adwords™, and Atlas™.

Although not shown in FIG. 1, e-commerce platforms also commonly feature an order management system, which collects and generates analytics data relating to purchase orders, and may include recording data relating to the number of items ordered, the price of the individual items, shipping costs and service costs. A non-limiting example of a commercially available order management system is Sterling Commerce™.

Customer relations analytics system 17, may record and generate customer analytics data, such as billing address, and customers' purchase history. Such data may, for example, be used by the marketing department of the ecommerce enterprise, to target specific customers with special promotions and/or offers on the basis of their purchase history. Non-limiting examples of commercially available customer relationship management (CRM) systems include Right Now®, Siebel™, and SAP™.

Competitor analysis system 11, may measure and generate comparative data relating to known competitors. For example, such systems may comprise use of a price comparison tool, which illustrates how a retailer's prices compare to a known competitor's prices. Such data may be used for assessing whether a retailer's online pricing is competitive in the marketplace. Non-limiting examples of commercially available competitor analysis systems include: Intoscape™, and InSiteTrack™.

The skilled reader will appreciate that all the separate analytics systems 9, 11, 13, 15, 17, and 27 illustrated in FIG. 1 are connected to the shared communications network 7. This ensures that data may be exchanged with the e-commerce server 3, and the enterprise management system 39. Furthermore, it is to be appreciated that the enterprise management system 39 of the present embodiment is arranged to receive and process both raw data as generated directly by the e-commerce server 3, and analytics data generated by the third party analytics systems 9, 11, 13, 15, 17, 27, or the native analytics modules 19. Going forward, the term ‘source data’ will be used to refer to raw and/or analytics data.

The e-commerce enterprise management system 39 of the present embodiment, may comprise an enterprise management server 41, comprising a data storage device 45. The enterprise management system 39 may be operatively connected to the shared communication network 7, via communications channel 43, enabling the exchange of source data with the e-commerce server 3, and one or more of the analytics system servers 9, 11, 13, 15, 17, 27. The enterprise management system 39 is arranged to obtain all the source data generated from the one or more analytics systems 9, 11, 13, 15, 17, 27, including receiving source data from the e-commerce server 3, generated by any analytics modules 19 native to the e-commerce server 3 if present. The enterprise management system 39 may comprise an application programming interface (API) to enable communication and/or access to the e-commerce server 3, and/or any one of the third party analytics systems 9, 11, 13, 15, 17, 27. The received source data is used by the enterprise management system 39 to perform a holistic performance analysis of the e-commerce enterprise.

In preferred embodiments, and source data is transferred from the e-commerce server 3, and/or the one or more analytics system servers 9, 11, 13, 15, 17, 27 on a regular basis to the enterprise management system 39, and specifically to the enterprise management server 41. This may comprise transferring source data at regular time intervals. In this way, the enterprise management system 39 may provide a holistic performance analysis and assessment on a periodic time basis. This might comprise on a daily basis, or any other user selected time period. It is important to note that the received source data, which effectively relates to a set of data, relates to data collected by the e-commerce enterprise 2 including the one or more third party analytics system over a defined time period. The enterprise management system 39 may provide a performance analysis and assessment for any time period that falls within the time range of received source data.

The source data may be transmitted to the enterprise management server 41 using push technology, wherein the data is periodically pushed to the server 41. Equally, the source data may be transmitted to the enterprise management server 41 using pull technology, wherein the required source data is requested by the enterprise management server 41 directly from the relevant e-commerce platform component (i.e. from the analytics system severs 9, 11, 13, 15, 17, 27 and/or the e-commerce server 3). On the basis of the received source data, the enterprise management system 39 is able to analyse the performance of the e-commerce enterprise, and specifically the performance of the online retail website. On the basis of this performance analysis, the enterprise management system is able to identify any underperformance (i.e. identifying underperformance), identify the sources of such underperformance, and to determine actions required to improve performance—i.e. increasing trading profit. In preferred embodiments, this information is presented to a user terminal 47 for review. The user terminal 47, shares a communication channel with the enterprise management system 39, and may be a personal computer. For example, the user terminal 47 may be operatively connected to shared communications channel 7 as illustrated in FIG. 1. The remaining description of the present embodiment describes how the enterprise management system 39 of the present invention is able to determine the required actions to increase trading profit for an online retail enterprise.

To aid the reader's understanding of the present invention, the functionality of the enterprise management system will be described as comprising a three stage process:
1) Performance Analysis;
2) Diagnosis; and
3) Problem Resolution.

The performance analysis stage comprises using a predetermined hierarchical performance measure framework, providing quantitative relationships between different performance measures, to generate a holistic analysis of the performance of the subject e-commerce enterprise. The diagnosis stage comprises identifying the one or more principal sources of an observed underperformance, using the results obtained during the performance analysis stage. The problem resolution stage comprises determining required actions to resolve the source of the underperformance identified during the diagnosis stage.

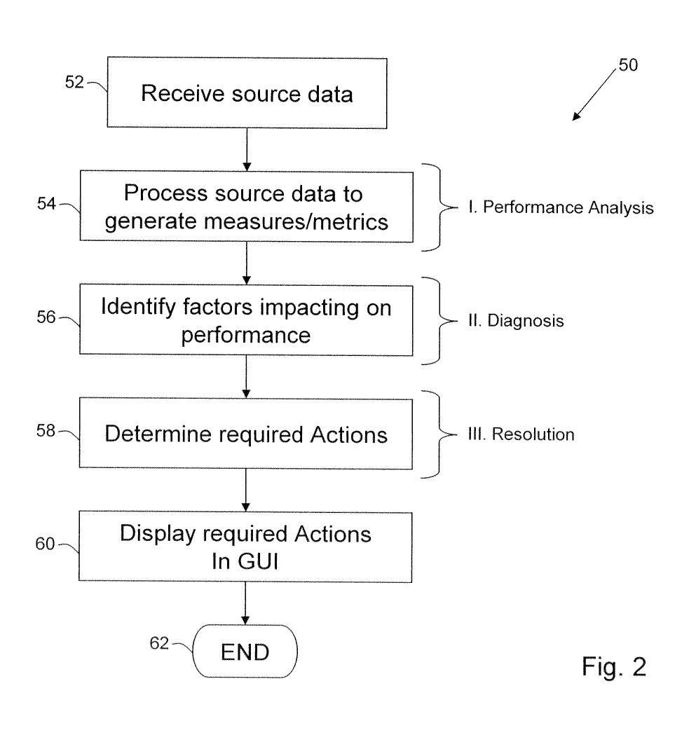

FIG. 2 illustrates a general overview of the method 50 used in accordance with the present embodiment, and specifically illustrates the method used by the enterprise management system 39 illustrated in FIG. 1.

The method is initiated by the receipt of source data by the enterprise management system 39, in step 52. As previously mentioned, and with reference to the general system overview illustrated in FIG. 1, this may comprise receiving source data from one or more of the e-commerce server 3, web analytics system servers 9, 11, 13, 15, 17, 27, or any other analytics system operatively connected to the e-commerce server 3. The received source data is processed in step 54 by the enterprise management system 39, which may comprise generating a plurality of measures and/or metrics in accordance with the underlying hierarchical performance measure relationship framework adopted by the enterprise management system 39, which are stored in the storage device 45 native to the enterprise management server 41. The calculated performance measures and the adopted hierarchical performance measure relationship framework allow a holistic assessment of the enterprise's performance to be determined, and relates to the aforementioned performance analysis stage.

Once the holistic performance analysis has been conducted, the factors responsible for any underperformance are identified in step 56—the diagnosis stage. This may comprise individually reviewing the calculated performance measures, and identifying those measures indicative of underperformance. Identified performance measures are then analysed in more detail to identify the sources of the underperformance.

Once the sources of the underperformance have been identified, the one or more actions required to improve the performance are determined in step 58—the resolution stage. One way of achieving this is to associate every input source data to one or more specific enterprise business areas of the subject retail enterprise system. Similarly, performance measures, and available actions may also be associated with specific enterprise business areas. In this way, identification of one or more performance measures indicative of a shortcoming, allows the enterprise management system 39 to identify the specific one or more business areas responsible for the performance shortcoming, in addition to allowing a set of potential actions to be identified. Further details regarding how individual actions may be identified is provided in the ensuing description.

Once the one or more actions required to improve the identified underperformance have been determined, they are displayed to the user of the enterprise management system 39 in a graphical user interface (GUI) in step 60, after which the method is ended in step 62.

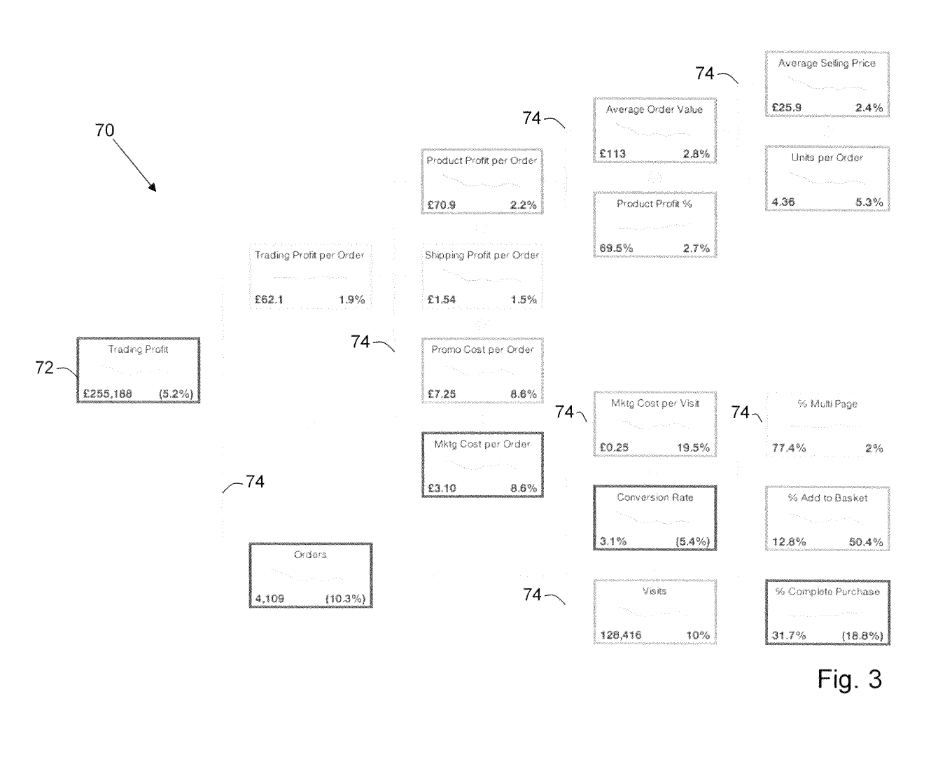

FIG. 3 is a graphical representation of an example hierarchical performance measure relationship framework 70, which illustrates the relationships between different KPIs and PIs, and may be used for performance analysis. Trading profit 72 is the principle KPI providing a holistic measure of the performance of the e-commerce enterprise. The PIs displayed on the right side of the hierarchical framework, are limited indicators of the performance of their associated enterprise business areas. Each branch 74 joining two or more performance measures is indicative of a mathematical relationship between the joined performance measures. Each of the performance measures will be a function of specific sets of source data.

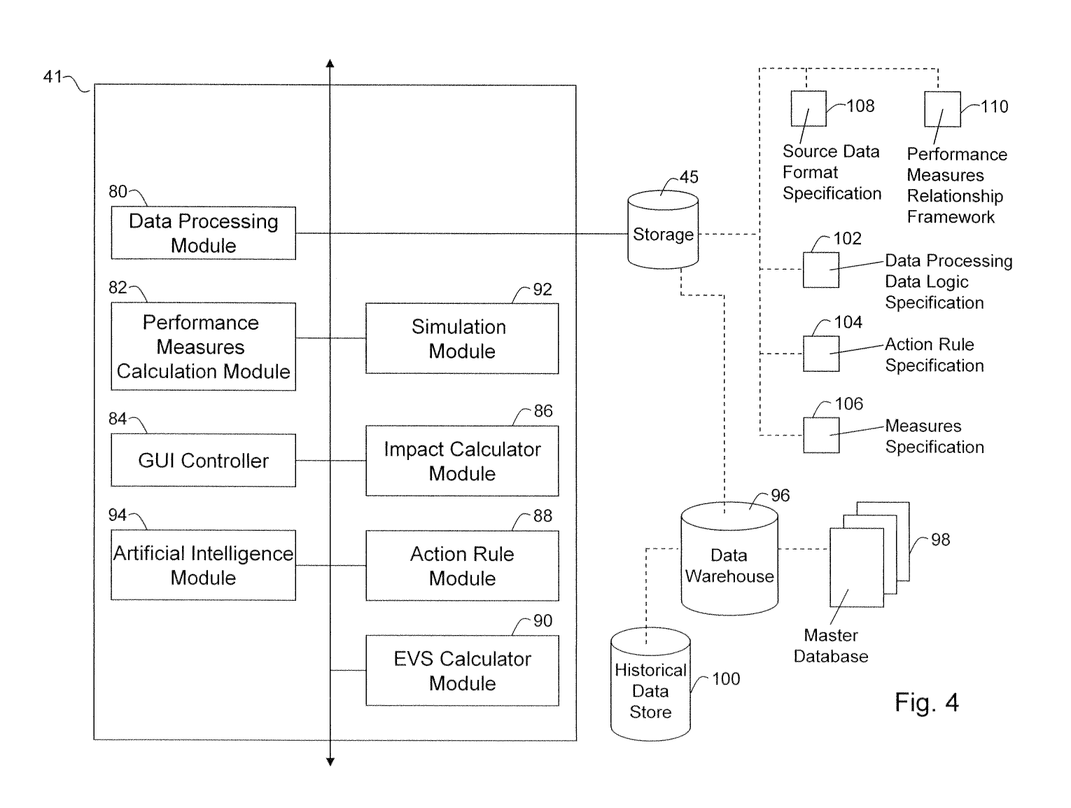

FIG. 4 is a functional overview of the enterprise management server 41 of the present embodiment, which may comprise the storage device 45. FIG. 4 illustrates the various different functional components, which may be comprised within the enterprise management server 41. These include: a data processing module 80, arranged to process data received from either the one or more analytics systems 9, 11, 13, 15, 17, 27 comprised within the e-commerce dashboard, as illustrated in FIG. 1, or data received from the e-commerce server 3; a performance measure calculation module 82 arranged to calculate the plurality of different performance measures, including PIs and KPIs; a graphical user interface (GUI) controller module 84 for graphically presenting data, including performance measures to the user, comprising means for presenting the data as graphs or other convenient and user-friendly data presentation means; an impact calculator module 86, arranged to calculate an ‘impact value’, or equivalently a contribution value to determine the sources contributing most to any identified performance shortcomings; an action rule module 88 for identifying required actions on the basis of an identified source of a performance shortcoming; an eCommera Value Score (EVS) calculator module 90, for calculating the actions likely to have the greatest impact on trading profit; a simulation module 92 for simulating the effects of implementing a selected action on the performance of the e-commerce enterprise; an artificial intelligence (AI) module 94 for amending and/or generating action rules, to improve the accuracy of the enterprise management system. The identified modules are provided for illustrative purposes only and are non-limiting. The skilled reader will appreciate that the functionality of any one of the identified modules may be provided by one or more different modules and such alternative embodiments fall within the scope of the present invention.

Additionally, the enterprise management server 41 is provided with access to a local storage device 45. Data processed by any of the modules native to the enterprise management server 41 are stored in a data warehouse 96 for future reference. The data warehouse may be comprised of one or more master databases 98. Each master database 98 may relate to a different ecommerce retail enterprise. In this way, the current system is able to manage and process raw data received from a plurality of different ecommerce enterprises and generate customised management advice simultaneously. Each different enterprise's processed data may be stored in a separate master database. Processed data may relate to any data required to generate the performance measures required to construct the hierarchical performance measurement framework of FIG. 3. An optional historical data store 100 is operatively connected to the data warehouse 96, and may comprise historical data relating to a specific enterprise. Such historical data may be used to generate a long term performance analysis review, and may also be used to improve the simulation module's 92 functionality. Raw data, received from the one or more analytics systems may be received on a continuous or periodic basis by the enterprise management server 41, using either push technology, or pull technology, or otherwise, such that either a continuous or periodic assessment and analysis of the performance of an e-commerce enterprise may be conducted. The skilled reader will appreciate that the raw data may equally be provided for by the analytics functionality native to the e-commerce platform components.

The storage device 45 may also comprise one or more of the following specifications used by modules 80, 82, 84, 86, 88, 90, 92, 94 to provide the required functionality: a data processing data logic specification 102, which defines logical associations between different types of raw data, required by the data processing module 80 to enable the processing of received data into a suitable format for future use; an action rule specification 104, which defines the associations between enterprise business areas, and action rules, in such a way that each enterprise business area is associated with one or more different action rules, which may be employed to generate a list of one or more actions; a performance measures specification 106, which defines the plurality of performance measures (including KPIs and PIs), and how they are calculated from received raw data; a source data format specification 108, which defines the required format of the processed data; performance measures relationship framework 110 (graphically illustrated in FIG. 3) which defines the hierarchical performance measures framework, providing a mathematical relationship between the different performance measures and how they relate to trading profit.

Further detail regarding the enterprise management system 39 of the present embodiment is set out below. The ensuing description is described with reference to the aforementioned three-stage process.

### I. Performance Analysis

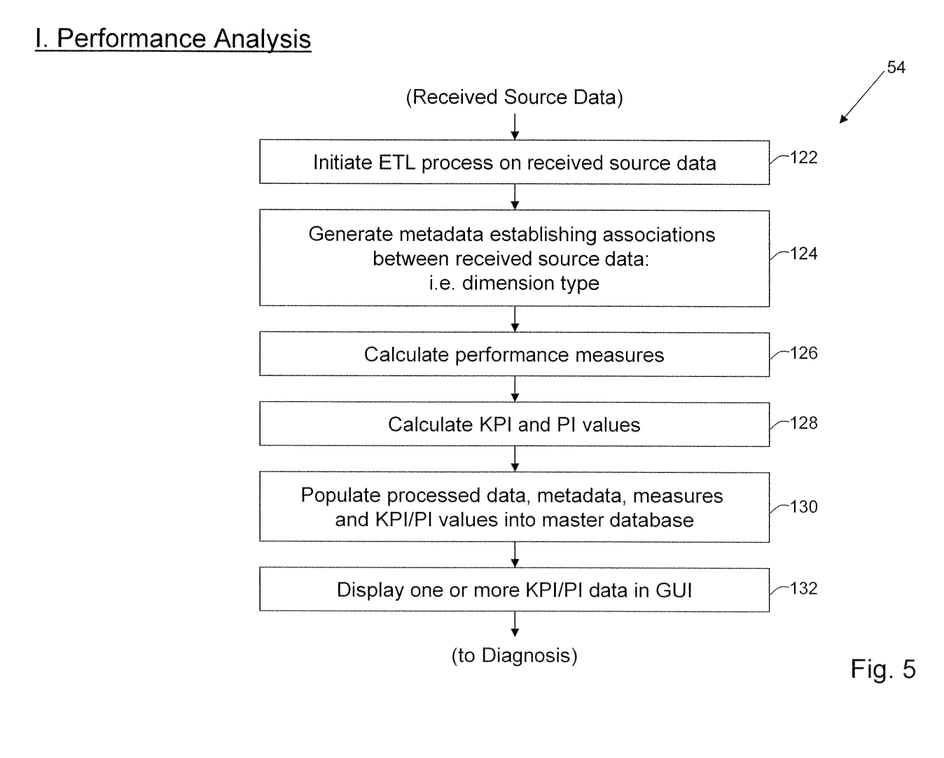

FIG. 5 is a more detailed process flow chart of method step 54 illustrated in FIG. 2. Specifically, the process flow chart of FIG. 5 illustrates a method, which may be used to process source data and generate performance measures, for use in conducting a performance analysis in accordance with the present embodiment. The method is initiated upon receipt of source data from the e-commerce server 3 of FIG. 1, or any of the analytics systems 9, 11, 13, 15, 17, 27, by the enterprise management server 41. The received data is processed in step 122 by the enterprise management server 41, and specifically by the data processing module 80 illustrated in FIG. 4. In some embodiments the data processing module 80 may comprise running an Extract, Transform, and Load process (ETL). In such embodiments, and as part of the transform stage of the ETL process, the received source data is transformed to generate source data having a specific format as defined in the source data format specification 108. Furthermore, in step 124, the data processing module 80 may generate metadata associated with the received source data. The metadata may relate to generating further information required to carry out the present method. For example, this additional metadata may relate to generating association data, in accordance with the data processing data logic specification 102, between the received source data. Equally, the generated metadata may relate to data characterising the ‘type’ of source data. In some embodiments, the data ‘type’ may relate to the origin of the source data—namely, a specific enterprise business area, i.e. marketing, product, etc. In short, all received source data is processed to generate metadata defining the data type, and data defining the associations between the different received source data, by making use of the data processing data logic specification 102, and the source data format specification 108. In this way, each received source data may be associated with at least one specific enterprise business area.

In steps 126 and 128 the performance measures, including KPI and PI values may be calculated by the performance measures calculation module 82, on the basis of the performance measure definitions comprised within the performance measures specification 106, and the performance measures relationship framework 110. Together, the performance measures specification 106 and the performance measures relationship framework 110 completely define every performance measure, and the relationship between the different performance measures.

In step 130 the processed source data, along with the calculated metadata, and the performance measures may be populated and/or loaded into a master database 98, comprised within the data warehouse 96, which is itself comprised within the storage device 45, accessible to the enterprise management server of the present embodiment. Effectively, this completes the ETL process. In preferred embodiments, each different e-commerce enterprise operatively connected to the enterprise management server 41, may be associated with a different master database. Unique identifiers may be used to ensure that only the authorised user is able to access the master database. The skilled reader will appreciate that whilst this is one way in which the data sets handled by the present system may be organised, other methods of organising the data may be used with the present system, and are not material to the present invention.

At this stage, the calculated performance measures may be graphically displayed to the user of the enterprise management system 39, by the GUI controller 84, as indicated in step 132. The calculated performance measures may be displayed as graphs, or any other visual representation. FIG. 3 provides an example of how the calculated performance measures may be graphically displayed. It is important to note that the calculated performance indicators may be functions of time, and what is being displayed is the time-variance of the performance measures over a specified period of time. Ultimately, to assess performance, rather than being interested in the specific value of a performance measure at a specific period in time, one is interested in time-variance of a performance variable. In this way, one can assess if the performance of a retail enterprise is improving or declining. For example, if the processed source data related to data generated over a two-week period, the illustrated performance measures, including the KPIs and PIs, may show the variance of the performance measures over that time period. This variance may be illustrated graphically, by means of graphs, or simply numerically. FIG. 3 shows KPI and PI time-variance both graphically (i.e. as graphs plotted over time) and numerically. The specified period of time may be user-defined, or may be source system defined on the basis of the available data. Where the period of time is user-defined, the time period may be selected on initiating the performance analysis stage, or at any other time. Where no time period is specified by default the performance measures calculation module 82 may calculate the broadest possible time-variance from the received source data. It is important to note that all received source data will comprise time and date information, such that it is possible from a cursory review of the received source data, to identify a time range over which the source data was generated.

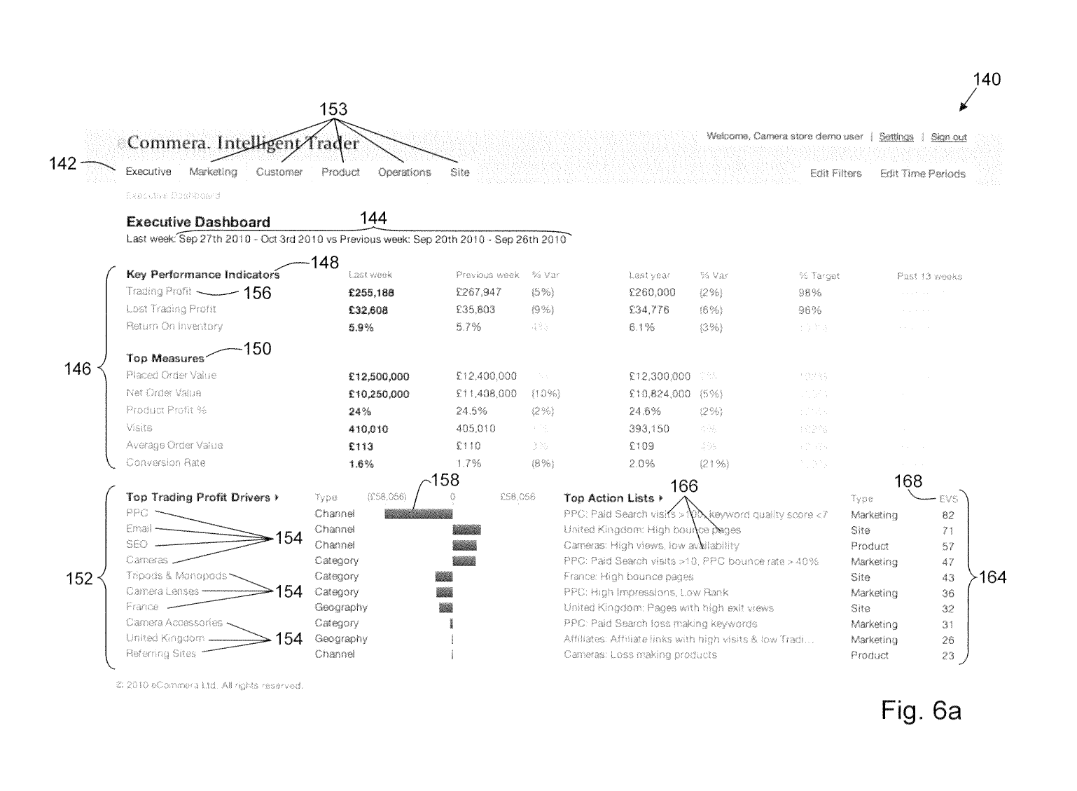

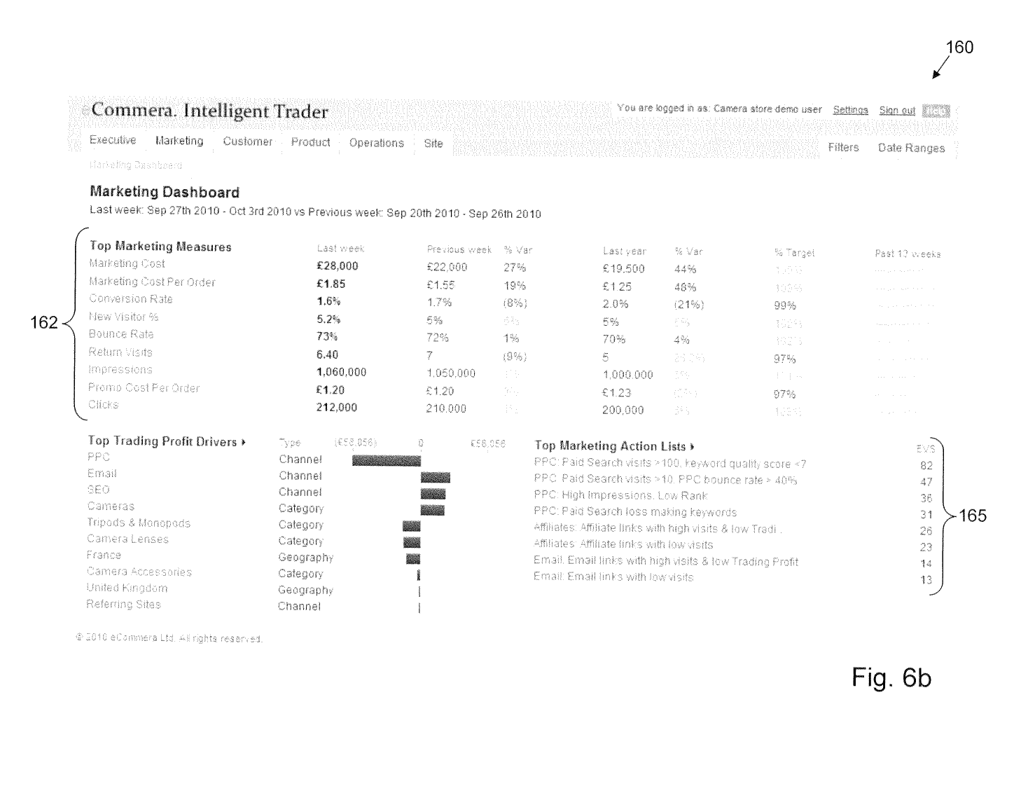

FIG. 6a is a screenshot of a dashboard 140, which may be displayed in a GUI on a user terminal 47 of FIG. 1. The illustrated screenshot relates to the ‘Executive’ dashboard, as indicated by the selected tab 142. Effectively, this dashboard provides a general holistic overview of the performance of the e-commerce enterprise, for the indicated time range 144. The dashboard is separated into different regions, each region conveys information pertinent to a different stage in the enterprise management process of the present embodiment. For example, information relating to the performance analysis stage is provided in region 146. Performance analysis information may relate to displaying the time-variance of KPIs 148 and PIs 150 as mentioned previously. The illustrated dashboard refers to PIs 150 as ‘Top Measures.’ The time variance of each displayed KPI and PI is displayed. Furthermore, the time variance of each KPI and PI may be colour coded to facilitate identification of decreased performance, for example red to indicate a decrease in performance, and green to indicate an improved performance.

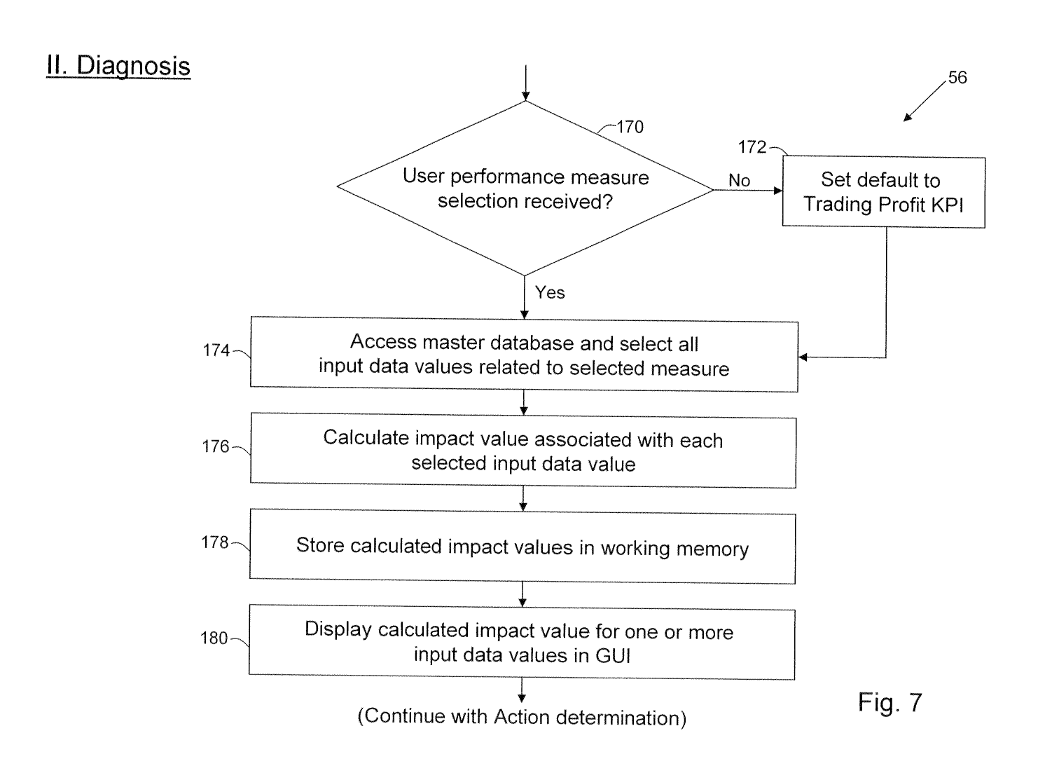

Region 152 displays a shortlist of the principal sources 154 of the observed variance in the trading profit KPI 156, and is relevant to the diagnosis stage of the method of the present embodiment, as indicated in step 56 of FIG. 2. Effectively, the sources 154 are processed source data generated, in preferred embodiments, during the ETL process outlined in FIG. 5. As mentioned previously, each source 154 is associated with an enterprise business area during, the ETL process, which defines the processed source data ‘type.’ Furthermore, an impact measure 158 is associated with each displayed processed source data 154. The impact measure 158 may be an approximate measure of the contribution the specific processed source data 154 is making to the trading profit KPI 156. In other words, it is a measure of how a specific processed source data 154 is impacting on trading profit KPI 156. Further details regarding how the impact measure 158 may be calculated are set out in the ensuing discussion of FIG. 7.

Each of the remaining five tabs 153, relate to the different enterprise business areas. Selecting any one of the remaining five tabs 153 will display the dashboard specific to the selected enterprise business area. Only information directly relevant to the selected business area is displayed. For example. FIG. 6b is a screenshot of the marketing dashboard 160. The difference with the executive dashboard of FIG. 6a is that the performance analysis region 162 is comprised exclusively of performance measures directly related to the marketing business area. In particular the performance analysis region 162 may display a selection of the most important marketing performance measures.

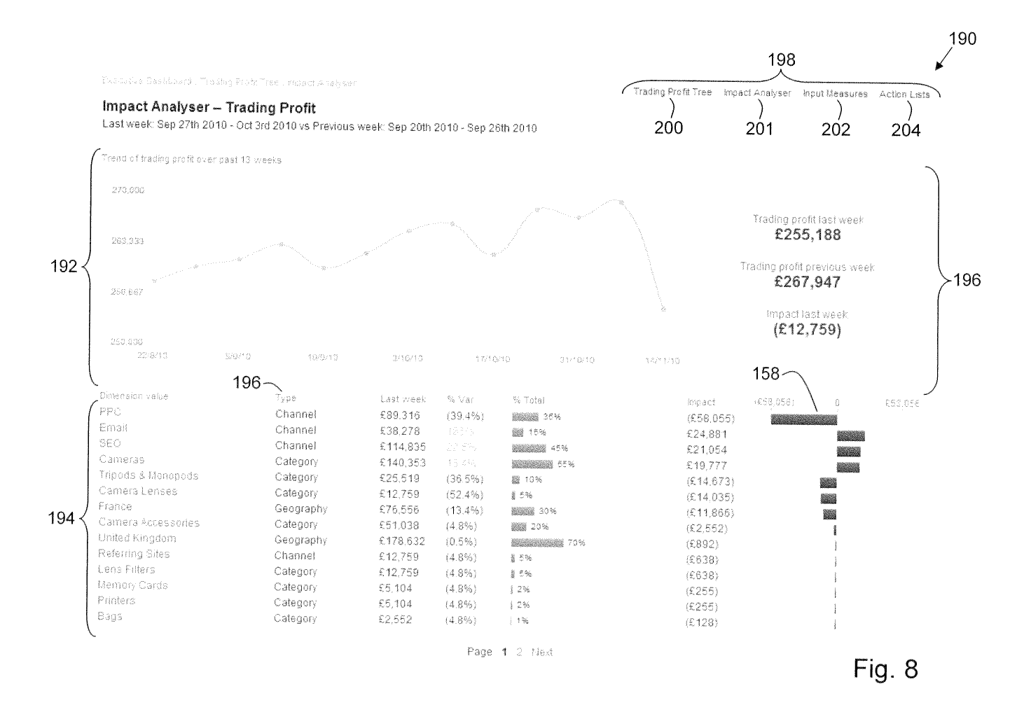

Turning to FIG. 6a, the action list region 164, provides a set of action lists 166, which the enterprise management server 41, and in certain embodiments the action rule module 88, has determined as being relevant to the diagnosed problem. To clarify, on the basis of the processed data 154 identified as being the source of a decline in trading profit, the system has determined the listed action lists 166 as requiring implementation to resolve the problem of declining profit. Each listed action list 166 is associated with an EVS (eCommera value score) value, which is an action impact value. The EVS value may be a normalized measure of the estimated impact implementing the related action list will have on trading profit. Further details of how the action lists are generated, their association with actions and the associated EVS value are described in the ensuing description of FIG. 8 below. Similarly, the marketing dashboard 160 of FIG. 6b also comprises an action list region 165, titled “Top Marketing Action Lists.” In contrast to action list region 164 of FIG. 6a, action list region 165 only displays the action lists associated with the marketing business area.

It is important to appreciate that whilst the GUI of the present enterprise management system may only highlight and display a shortlist of the most relevant performance measures, and processed source data, the enterprise management system 39 calculates all performance measures, and determines impact values for each processed source data. This feature is important, since it allows the present system to identify any underperformance, which may not be otherwise discernable, simply from an analysis of the KPI. For example, overperformance in one enterprise business area, may disguise underperformance in a separate enterprise business area. In such a situation, a review of the performance measures may not highlight the presence of the underperformance. By determining the impact each processed source data and performance measure has on trading profit, the present enterprise management system 39 can identify the source of any underperformance even where such underperformance is not discernable from the KPIs and/or PIs.

### II. Diagnosis

Once the performance analysis is complete, and the time-variance of each performance measure has been calculated, the enterprise management system 39 may proceed with the diagnosis stage, wherein the impact each processed source data has on a selected performance measure is determined. This process may be referred to as impact analysis. By default, the impact analysis is carried out in respect of trading profit, as illustrated in the executive dashboard of FIG. 6a. However, it is to be appreciated that the impact analysis may be carried out in respect of any user selected performance measure.

FIG. 7 is a process flow chart, illustrating the detailed method steps comprised within the diagnosis stage 56 of FIG. 2, which may be carried out by the impact calculator module 86, itself comprised within the enterprise management server 41. The process 56 is usually executed after the performance measure calculations have been completed. The process 56 is initiated by the server 41, querying whether a user performance measure selection has been received, in step 170. The user performance measure selection indicates which performance measure the impact analysis is to be conducted with respect to. As mentioned previously, the default selection is the trading profit KPI, since this measure provides a holistic view of enterprise performance. Accordingly, in step 172 the trading profit KPI is selected by default, in the event that no user selected performance measure has been received. Otherwise, the remaining method steps 174 to 176 are carried out in respect of the received user selected performance measure.

In step 174, the impact calculator module 86 accesses the master database 98 relevant to the subject enterprise, and identifies the processed source data relevant to the selected performance measure (i.e. either a user selected performance measure, or the default trading profit KPI). It is important to recall, that each processed source data comprised within the master database 98, is associated with one or more enterprise business areas. In the ensuing description, the processed source data may be interchangeably referred to as ‘input data’. As mentioned previously, the one or more enterprise business areas input data is associated with, may be referred to as the input data ‘type.’ Similarly, and as mentioned previously, each performance measure is also associated with a data ‘type’, and may be defined in the performance measures specification 106. The relevant input data is identified in step 174, by matching the data types. To clarify, the impact calculator module 86 identifies the set (i.e. one or more) of input data sharing the same data type as the selected performance measure. Ultimately, a performance shortcoming highlighted by a specific performance measure, must be attributable to the input data the subject performance measure is dependent on. Accordingly, using shared data types to generate sub-sets of input data associated with the selected performance measure, improves the efficiency, by reducing redundancy—namely, the impact analysis calculations are only carried out on an identified sub-set of the input data set, the sub-set relating to input data associated with the selected performance measure. It is to be appreciated that the master database 98 may comprise a very large set of input data. Accordingly, performing calculations on each input datum comprised within the set may be processor intensive and time consuming. Reducing calculations to sub-sets of input data is a more efficient use of the processing capabilities of the enterprise management server 41, especially where it is likely that a portion of the data comprised within the input data set is not associated with the selected performance measure, and accordingly an impact analysis of such data will convey no useful information.

Once the input data sub-set associated with the selected performance measure has been identified, the impact value of each input data comprised in the sub-set is calculated in step 176. The impact value calculation may be carried out by the impact calculator module 86. An impact value is calculated for each member comprised within the sub-set. Whilst the impact analysis region 152 of the Executive Dashboard 140 illustrated in FIG. 6a, only displays a shortlist of the input data having the largest associated impact values 158, it is important to note that an impact value is calculated for each input data associated with the selected performance measure, which is trading profit in FIG. 6a. Similarly, it is important to note that a KPI such as trading profit is likely to be a function of different types of input data (i.e. input data associated with different enterprise business areas). Accordingly, calculating the impact value of the input data associated with such a KPI, is likely to include a variety of different types of input data.

Furthermore, when calculating, the impact values associated with an input data, the impact calculator module 86 may access the performance measure specification 106 and the performance measure relationship framework 110, which the reader may recall, define each performance measure, and define the mathematical relationships between different performance measures. In this way, the impact calculator module 86 is able to determine the impact an individual input data has on the selected performance measure. As mentioned previously, the impact value of a specific input data, is effectively a measure of the effect variance of the input data has on the selected performance measure, when all other input data are held constant.

In step 178, the calculated impact values associated with the relevant input data are stored in, alternatively working memory native to the enterprise management server 41 (not shown in FIG. 4), or in storage device 45. In some embodiments, the impact value data may be stored in the historical data store 100. In such embodiments, the calculated impact values are stored for future reference. In particular, the calculated impact values may be stored and used to improve the algorithms used to calculate the impact value. For example, this functionality may be provided by an artificial intelligence (AI) module 94, or alternatively may be provided manually.

Once the impact values have been calculated and stored, they are also displayed in a GUI on the user terminal 47, by the GUI controller 84, in step 180. As illustrated in FIG. 6a, only a selection of the data inputs having the largest associated impact values are displayed in the executive dashboard screen. The data inputs with the largest associated impact values may be viewed as the most significant sources of any identified performance shortcoming. A complete review of the impact values for the data inputs associated with the selected performance measure, may be obtained by accessing the impact analyser screen described below. Step 180 effectively completes the diagnosis stage.

FIG. 8 illustrates an example of the impact analyser screen 190, which may be accessed via the executive dashboard screen 140 of FIG. 6a. This may be achieved by selecting any one of the performance measures in region 146 of FIG. 6a, and subsequently selecting the impact analyser tab 201 associated with the selected performance measure. The impact analyser screen illustrated in FIG. 8, is associated with the trading profit KPI, accessed by selecting ‘Trading Profit’ 156, and then selecting the impact analyser tab 201. The impact analyser screen 190 may comprise a graph 192, illustrating how the trading profit KPI has varied over a time period. In the illustrated example, the trading profit KPI variance is graphically displayed over a thirteen week period. The impact values 158 are calculated for each input data value 194. Due to the number of input data associated with the trading profit KPI, only a selection are illustrated in the screenshot 190, with the remaining input data illustrated on a subsequent webpage (not shown). The input data type 196 of each input datum is also indicated, and specifically the sub-types are indicated. For example, PPC (pay per click) relates to the trading profit generated from advertising on search engines, such as Google™, due to internet users clicking on adverts. This input data is a marketing type data. However, one can further sub-divide the marketing type into several different sub-categories, such as ‘Channel’, and/or ‘Geography’ to name but a few of the different sub-types available. The Geography sub-type may be used to further disaggregate marketing input data according to geographic location, which may be useful in situations where an enterprise is running an international marketing campaign and wishes to be able to assess the marketing performance by geographic region. The different sub-categories may be defined on the basis of the underlying data structure of the source data received from the e-commerce enterprise 2. Accordingly, different e-commerce enterprises may be associated with different sub-categories. The impact analyser screen 190 also comprises a quantitative summary 196 of the selected performance measure.

The impact analyser screen 190 also comprises tabs 198 which may provide the user with further useful information. For example, when selected the trading profit tree tab 200 displays the screen illustrated in FIG. 3, which is a graphical illustration of the relationship framework between the different performance measures. Specifically, it provides a graphical relationship framework illustrating the relationship of the selected performance measure (trading profit in the current example). For example, a different relationship framework would be displayed if a different performance measure was selected.

The impact analyser screen 190 also comprises an input measures tab 202, which provides a comprehensive list of all data inputs, arranged by type, associated with the subject e-commerce enterprise operatively connected to the enterprise management system 39.

Similarly, the impact analyser screen 190 also comprises an action lists tab 204. Further details of this tab are provided below in the ensuing discussion of the problem resolution stage.

### III. Problem Resolution

Once the sources of any one or more shortcomings have been identified, the enterprise management system 39 may begin to determine the actions required to resolve the identified shortcomings.

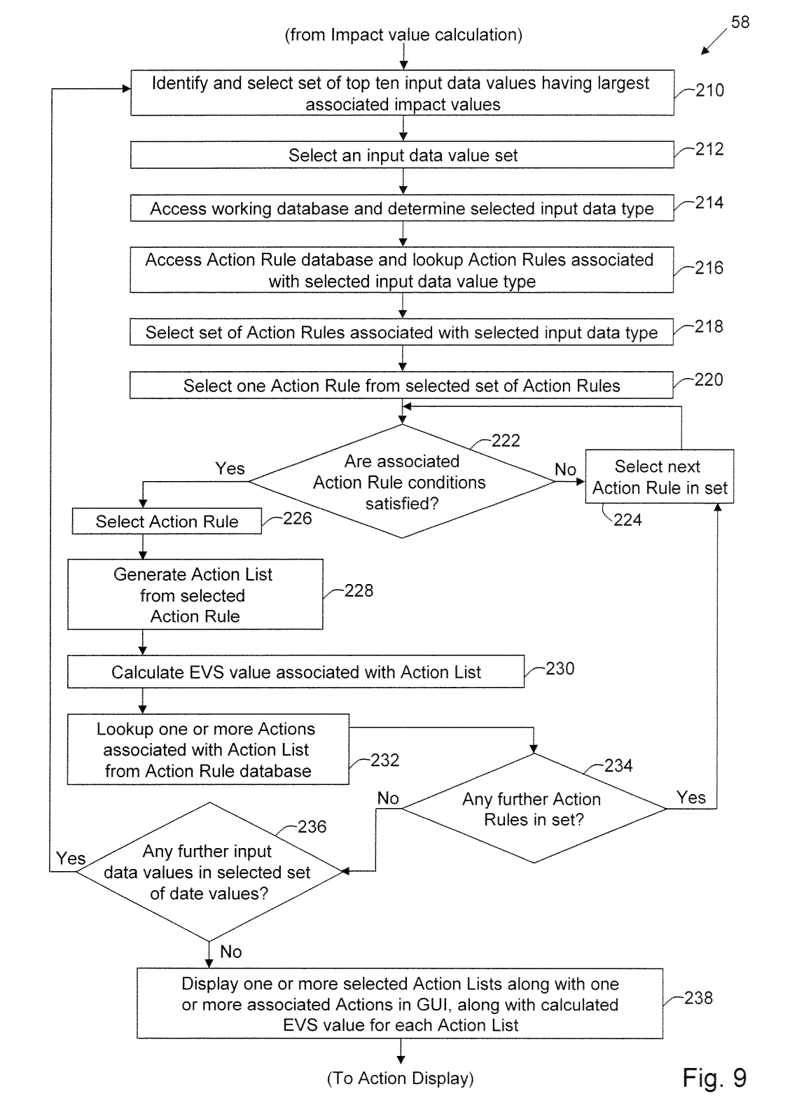

FIG. 9 is a process flow chart illustrating a detailed breakdown of the method steps which may be comprised in method step 58 illustrated in FIG. 2, in accordance with the presently described embodiment. As mentioned previously, the objective of the problem resolution stage is to identify one or more actions, which if implemented will resolve the identified enterprise performance shortcoming. The one or more required actions are determined on the basis of the identified input data, and specifically on the basis of the input data type.

In the presently described embodiment, the data types of the input data having the largest associated impact values, are associated with pre-defined action rules, defined in the action rule specification 104 illustrated in FIG. 4. Each action rule is then used to generate one or more action lists, which in turn are each associated with one or more specific actions. In this way, once the data types of the set of input data having the largest associated impact values have been identified, the associated one or more action rules may be determined using the action rule specification 104. In turn the associated action rules are used to generate one or more action lists, which associate one or more required actions to the one or more sources of the identified performance shortcomings—namely, to the one or more identified input data. It is important to note that the process flow chart illustrated in FIG. 9 is one example of how the method step 58 may be implemented, but other alternative examples are also envisaged, and fall within the scope of the present invention. It is important to note that in certain circumstances, the generated action lists may relate to one action, and in other circumstances a generated action list may relate to a plurality of different actions. Similarly, one action rule may be associated with a single action list, or alternatively with a plurality of action rules.

The problem resolution stage may be initiated by selecting a subset of the input data having the largest associated impact values from the enterprise management server's 41 working memory (not shown), or alternatively from the server's 41 storage device 45. For example, and with reference to FIG. 6a, this might comprise selecting the ten input data values 154 having the highest associated calculated impact values 158. Alternatively, it could comprise selecting a set of input data associated with an impact value exceeding a predetermined threshold value.

On a side note, and on the basis of practical considerations, the skilled reader will appreciate that identifying and selecting every input data having a negative impact on enterprise performance may not be necessary for the purposes of increasing enterprise performance. Rather, exclusively identifying the input data having the largest impact on performance, and addressing only the associated shortcomings, may often be sufficient to improve performance. To illustrate this point further, consider FIG. 6a, which illustrates a plurality of input data 154 having associated impact values 158. Whilst it is clear that the ‘United Kingdom’ input data value is impacting on trading profit, its impact is relatively small and insignificant when compared to the impact the PPC input data value is having on trading profit. Accordingly, simply resolving the PPC shortcoming may be sufficient to increase trading profit significantly. It goes without saying, that further ‘fine-tuning’ of the performance of the e-commerce enterprise may be desirable, to further increase trading, profit. However, identifying and resolving the shortcomings associated with the input data values having, the largest impact on trading profit (as determined by the associated impact value), will have the largest effect on improving trading profit. It is resolving the shortcomings associated with the input data values having the largest impact on trading profit, that a manager of an e-commerce enterprise will want to prioritize.

FIG. 9 illustrates an embodiment where a set of the top ten input data values 154 having the largest associated impact values 158 are selected, in step 210. In step 212, one input data value is selected from the set of selected input data values. For example, this might comprise selecting the input data value having the largest associated impact value within the set. In step 214, the master database 98 may be accessed to identify the data type of the selected input data value. This step may be conducted by the action rule module 88. On the basis of the identified data type, the action rule module 88 may subsequently access the action rule specification 104, to identify the set of action rules associated with the data type of the selected input data, in step 216. In step 218, the set of action rules associated with the input data type are selected by the action rule module 88. At this stage, the data type of the selected input data value identified as a source of a performance shortcoming has effectively been used to narrow the set of available action rules comprised in the action rule specification 104, to a subset of potentially relevant action rules. However, it is still necessary to probe further to identify the one or more action rules relevant to the diagnosed problem.

Each action rule defined in the action rule specification 104, has an associated threshold value. These threshold values may be thought of as boundary conditions defining the enterprise conditions when a specific action rule may be applicable. Accordingly, it is necessary to determine which one or more action rules comprised within the selected set are applicable, by determining whether the associated threshold conditions are satisfied.

In step 220, one action rule is arbitrarily selected from the set of selected action rules. In step 222, the action rule module 88 determines if the associated threshold conditions are satisfied. The threshold conditions associated with each action rule are defined in the action rule specification 104. Accordingly, the action rule module 88 may access the action rule specification 104, to lookup the threshold conditions associated with the action rule selected in step 220. If the action rule module 88 determines that the threshold conditions are not satisfied, then the next action rule comprised in the set of action rules is selected in step 224, and step 222 is repeated, until an action rule, comprised in the selected set, is identified, whose threshold conditions are satisfied. In which case, the subject action rule is selected in step 226.

In step 228, the action list is generated using the action rule selected in step 226, which is applied to the received source data comprised in the subject enterprise's master database 98. It is important to recall that the action rule specification 104, defines every available action rule, and associates action rules with input data types and defines the associated threshold conditions. Action lists are lists of one or more individual actions required to resolve an identified performance shortcoming. In the presently described embodiment, the relevant action lists are generated by applying the relevant one or more action rules to the subject enterprise's source data, which is comprised in the enterprise's master database 98. In this way, the relevant one or more action lists may be generated from the action rule selected in step 226.

In step 230, the EVS (eCommera value score) associated with the determined action list is calculated. The EVS calculation may be carried out by the EVS calculator module 90. As mentioned previously, the EVS value is an indication of the estimated effect implementing the actions comprised in a specific action list will have on trading profit. The EVS may be determined by estimating the effect on trading profit, implementing the actions comprised within a specific action list will have, when all other action lists are held constant. As mentioned previously, in the present embodiment, the EVS is normalized on a scale having values ranging from 0 to 100, with larger EVS values indicative of greater estimated impact on trading profit, and vice versa.

In step 232, the action rule module 88 may lookup the one or more actions associated with the selection action list, from the action rule specification 104. In step 234, the enterprise management server 41 may query if any further action rules are present in the set of action rules associated with the selected input data type, selected in step 218. If further outstanding action rules are present in the selected set, then the next action rule in the set is selected, as described in step 224. Method steps 222 to 234 are repeated, until all action rules present in the selected set have either been discarded as not applicable (as a result of their threshold conditions not being satisfied), or have been shown to be applicable and the associated actions lists and EVS values determined.

Once each action rule in the set of action rules associated with the data type of the input data value selected in step 212, has been assessed, then the enterprise management server 41 queries, in step 236, if any further input data values are present in the set of input data values selected in step 210. Method steps 212 through 236 are repeated for each input data value comprised in the selected input data value set of step 210. In this way, the enterprise management server 41 is able to generate an action list, and accordingly one or more actions, associated with each identified input data value, within the set of input data values having the largest impact (as determined by the impact analysis value 158) on trading profit. Furthermore, the enterprise management server 41, and in the present embodiment, specifically the EVS calculator module 90, is also able to quantify the estimated effect on trading profit, implementing each generated action list may have. This is achieved by calculating an EVS value for each identified action list.

In step 238, the identified action lists are displayed within the GUI of the user terminal 47, terminating the problem resolution stage.

The skilled reader will appreciate that whilst the preceding description of an embodiment of the present invention is described with respect to identifying the sources of enterprise underperformance, and resolving the identified underperformance. The described embodiment may equally be used to identify the sources of overperformance (i.e. identifying input data having a positive impact on trading profit), and determining which actions resulted in the overperformance. In this mode of operation, the historical data store 100 of FIG. 4 may be particularly useful.

The historical data store 100 may be used to store data relating to implemented management decisions. For example, implemented actions and/or action lists, along with the associated input data values and associated impact values, may be stored in the historical data store 100. In this way, when an input data value associated with a positive impact analysis value is identified, the historical data store 100 can be accessed to determine which implemented action and/or action list resulted in the over-performance. The data type of the input data associated with the positive impact analysis, may be used to identify the action list and/or one or more actions responsible for the observed over-performance. Furthermore, the effect of the implemented one or more actions and/or action lists may be quantified, by comparison of present input data, gathered after implementation of the one or more actions and/or action lists, with the historical data taken prior to implementation of the one or more actions and/or action lists. Storing and reviewing historical data is advantageous insofar that it provides an assessment means for the present enterprise management system 39 to evaluate the predictive accuracy of the underlying mathematical models used. Namely, do the determined action lists and/or actions improve trading profit as predicted? And if so, by how much? Such an assessment may be incorporated into an Artificial Intelligence (AI) module 94. The AI module 94 may then use the results of such assessments to refine the adopted mathematical model—i.e. the hierarchical performance measure relationship framework—to improve the mathematical relationships between the different performance measures, to more accurately reflect observation.

Furthermore, the AI module 94 may also be used to generate the action lists in step 228 of FIG. 9. In such an embodiment, the AI module 94 may incorporate historical data stored in the historical data store 100, in its calculations when generating action lists on the basis of the one or more determined action rules and the received input data. Implemented actions may then be stored, along with the observed effects, as mentioned previously in the historical data store 100, or alternatively in the master database 98. This data may then be used by the AI module 94, as described above, to improve the underlying algorithms used in generating action lists from action rules. Equally, the AI module 94 may be used to generate new action rules if required, on the basis of the historical data, as indicated previously.

In similar fashion, data comprised in the historical data store 100, may be used by simulation module 92, to simulate the impact of implementing selected actions and/or action lists will have on the different performance measures, including the impact on trading profit.

The skilled reader will appreciate that the above described functionality is especially useful in a management decision-making process, allowing the effect of an implemented action to be retrospectively assessed and quantified. Such quantified analysis establish precedents, which may be used for more accurately estimating the benefit of varying one or more levers in future decision making processes, by improving the underlying mathematical models and/or algorithms used in the various diagnosis, and problem resolution stages of the present invention.

Although the herein provided description of the preferred embodiment has been described with the objective of identifying a problem with the performance of an e-commerce enterprise, the skilled reader will appreciate that once the relationship between generated source data, performance measures, and available actions have been quantified, the methods of the described embodiment may be adapted for use in simulating the effects implementing specific actions may have on a defined objective. The AI module 94 may be trained to monitor and retrospectively record the effects implementing and varying selected actions have had on the defined objective as previously described. The actual recorded effects may be cross-referenced with the predicted effects and used to improve the functionality of the AI module 94. Furthermore, this improved functionality will result in the AI module 94 generating more accurate predictive models by generating more accurate simulations of the effects implementing specific actions will have on the defined objective. Similarly, the AI module 94 may also be used to improve the underlying hierarchical performance measure relationship framework, such that predicted results more closely mirror observed results. In this respect, irrespective of the validity of the adopted hierarchical performance measure relationship framework used initially, due to the continuous cross-referencing of predicted results with observed results, and the AI module 94 subsequently continuously improving the underlying relationship framework, eventually the relationship framework will be accurate, and predicted results will closely mirror observed results.

Equally, it is envisaged that the present enterprise management system 39 is able to generate management advice in real time. In such embodiments it is envisaged that one or more e-commerce enterprise servers are continuously connected to the e-commerce management server 41, continuously providing the server 41 with source data. The only limitation to the real time processing of the management server 41 is its processing power. Accordingly, as processing power increases this will not be an obstacle.

It is envisaged that the presently described enterprise management system 39 may be arranged to receive source data directly from one or more different types of sources. For example, such types of sources may relate to telephones, mobile telephones, electronic point of sales (EPOS) terminals, electronic kiosks, and offline and/or physical sources.

The action rule specification 104 may be configured to associate each action rule with one or more different action lists, which in turn are associated with one or more actions as defined in the specification 104. In such an embodiment, rather than the action rules being used to generate one or more action lists, action lists are simply associated to the relevant action rules by performing a lookup operation. Such an embodiment may be suitable for use with relatively simple systems, where the different available actions are relatively low in number.

### Worked Example

In practice a user may interact with the present enterprise management system 39 via user terminal 47. It is assumed that the e-commerce enterprise 2 has transmitted data generated by either internal analytics modules 19, or any one of the plurality of third party analytics systems 11, 13, 15, 17, 25, 27 to the enterprise management server 41, and the received data has been processed as described above, and populated into the master database 98 illustrated in FIG. 4. Upon establishing a data connection with the enterprise management system 39, the user may be presented with the Executive Dashboard screen 140 illustrated in FIG. 6a, which provides a holistic performance overview of the e-commerce enterprise 2, in region 146 of the dashboard 140. Equally, a selection of the sources having the greatest determined impact on the observed trading profit KPI variance, are presented in region 152 of the dashboard 140; and a selection of the action lists determined as likely to have the greatest impact on improving the observed performance variance are displayed in region 164.

The user is immediately able to see, without having to exercise any expertise, the source having the most significant impact on the default trading profit KPI, in addition to a selection of proposed Action Lists estimated as having the biggest impact on the trading profit KPI if implemented.

The user may then select any one of tabs 153 to access the dashboards associated with specific business areas of the e-commerce enterprise. For example. FIG. 6h illustrates the Marketing Dashboard.

In each dashboard the user may also investigate the sources contributing to any one selected performance measure related to the selected business area. For example, the user may select any performance measure displayed in region 146 in the Executive Dashboard screen 140. For example, when the trading profit KPI 156 is selected, the user may be presented with the Impact Analyser screen 190 of FIG. 8, or alternatively any one of the screens associated with tabs 198. For example, the trading profit tree tab 200, when selected presents the performance measure hierarchical relationship framework illustrated in FIG. 3, graphically displaying the relationship between the different performance measures. The input measures tab 202, when selected, presents a screen listing the set of source data associated with the selected performance measure (which in the present example is the trading profit KPI). The impact analyser screen illustrated in FIG. 8 provides a complete list of all the data sources, and their associated impact values, affecting the selected performance measure. Similarly, selecting the action lists tab 204, presents a screen listing all the action lists associated with the observed performance measure variance. Furthermore, filters may be applied to any selected screen to filter the graphically presented information. For example, within the impact analyser screen 190, the user may wish to see data sources associated with a specific data type and/or category (i.e. data sources associated with a specific enterprise business area), or sub-type/category.

What is claimed is:

1. A computer system for determining a significant source of variance in a performance measure of a complex entity during a time period, the system comprising:
a data processing module arranged to receive a plurality of data elements and to relate the plurality of data elements to a predetermined key performance measure;
a data storage device storing a relationship specification defining a mathematical relationship between the plurality of data elements and the key performance measure;
a performance measure calculation module arranged to calculate a value of the key performance measure from the received data elements using the relationship specification and hence a variance in the determined value over the time period; and
an impact identification module arranged to determine the impact of each data element on the determined variance, by calculating a contribution value of each data element for the determined variance and identifying the most significant source of the determined variance as the data element with the greatest determined impact.

2. The computer system of claim 1, wherein:
the data processing module is arranged to relate the plurality of received data elements to a plurality of different predetermined key performance measures;
the relationship specification defines the mathematical relationship between the plurality of data elements and the plurality of key performance measures; and
the performance measure calculation module is arranged to calculate a value for each of the plurality of key performance measures and a variance in each of the determined values over the time period.

3. The computer system of claim 1, wherein the relationship specification defines a hierarchical mathematical relationship between a plurality of different key performance measures.

4. The computer system of claim 1, wherein the relationship specification defines a hierarchical mathematical relationship between a plurality of different key performance measures and intermediate performance measures.

5. The computer system of claim 1, wherein at least some of the data elements comprise intermediate performance measures.

6. The computer system of claim 1, wherein the contribution value of each data element is calculated by changing the value of the data element, and holding all other data elements constant for each determined variance.

7. The computer system of claim 1, wherein the impact identification module is arranged to identify a plurality of the data elements which provide the most significant impact on the determined variance.

8. The computer system of claim 1, wherein the data elements are received from an analytics system for analysing the operation of the complex entity.

9. The computer system of claim 1, wherein the complex entity is an enterprise and the data elements are received from a computer system of the enterprise.

10. The computer system of claim 9, wherein the enterprise comprises an e-commerce enterprise.

11. The computer system of claim 1, wherein the performance measure is related to a specific section of the complex entity.

12. The computer system of claim 11, wherein the complex entity is an enterprise, the data elements are received from a computer system of the enterprise and the specific section of the complex entity comprises an enterprise category.

13. The computer system of claim 11, wherein the performance measure calculation module is arranged to calculate the value of the performance measure from a subset of the received data elements, the subset relating to the specific section of the complex entity; and
the impact identification module is arranged to determine the impact of each of the data elements of the subset on the determined variance, by calculating a contribution value of each data element of the subset.

14. The computer system of claim 13, wherein the performance measure calculation module is arranged to select the subset of received data elements which relate to the same specific section of the complex entity as the performance measure.

15. The computer system of claim 1, wherein at least some of the plurality of data elements comprise an intermediate performance measure or wherein at least some of the plurality of data elements are used to create an intermediate performance measure using the relationship specification.

16. The computer system of claim 15, further comprising:
a data storage device storing an action specification, the action specification relating different combinations of data elements and/or intermediate performance measures and different thresholds for the value of the data elements and/or the intermediate performance measures to one or more different actions; and
an action rule module arranged to determine one or more different actions to be taken as a consequence of calculating a significant variance in the key performance measure, the action rule module determining the resultant action by use of the values of the data elements and/or the intermediate performance measures identified as the source of the significant variance and the action specification.

17. The computer system of claim 16, wherein the action rule module is arranged to determine one or more different actions to be taken as a consequence of calculating the most significant variance in the key performance measure of a specific section of the complex entity, from a subset of the received data elements which relates to that specific section of the complex entity.

18. The computer system of claim 16, further comprising
an action impact value calculator module arranged to calculate, using the relationship specification and the action specification, an impact value for each different action determined by the action rule module, the impact value providing a measure of the estimated impact of an action on the performance measure.

19. The computer system of claim 18, further comprising:
an action ranking module arranged to determine the rank of each action determined by the action rule module, using the associated impact value calculated by the action impact value calculator module.

20. The computer system of claim 19, further comprising:
a user terminal; and
a graphical user interface (GUI) controller arranged to display in a graphical user interface on the user terminal, the one or more actions determined by the action rule module, the controller displaying the one or more actions according to the determined ranking.

21. The computer system of claim 20, wherein the GUI controller is arranged to filter the one or more actions to be displayed on the basis of a user-selected specific section of the complex entity and to display the filtered one or more actions.

22. The computer system of claim 20, wherein the GUI controller is arranged to display in the GUI the one or more data elements that have been determined by the impact identification module as being the most significant source of the determined variance.

23. The computer system of claim 22, wherein the GUI controller is arranged to filter the one or more data elements to be displayed on the basis of a user-selected specific section of the complex entity and to display the filtered one or more data elements.

24. The computer system of claim 1, wherein the performance measure is the complex entity's trading profit.

25. The computer system of claim 1, wherein the variance in the performance measure value is indicative of a decrease in the complex entity's performance over the time period.

26. The computer system of claim 1, wherein the system is operatively connected to a communications channel shared with the complex entity.

27. The computer system of claim 26, wherein a plurality of different entities are operatively connected to the system via the shared communications channel, and the plurality of received data elements are associated with the plurality of different entities.

28. The computer system of claim 1, wherein the plurality of data elements are received in real-time;
the performance measure value is calculated in real-time;
the contribution value of each data element is determined in real-time; and
the most significant source of the variance is determined in real-time.

29. The computer system of claim 16, further comprising:
a simulation module arranged to simulate the effect that implementing any one of the actions determined by action rule module the will have on the key performance measure.

30. A computer-implemented method of determining a significant source of variance in a performance measure of a complex entity during a time period, the method comprising:
receiving a plurality of data elements;
relating the plurality of data elements to a predetermined key performance measure;
storing a relationship specification defining a mathematical relationship between the plurality of data elements and the key performance measure;
calculating a value of the key performance measure and hence a variance in the determined value over the time period;
determining the impact of each data element on the determined variance, by calculating a contribution value of each data element for the determined variance; and
identifying the most significant source of the determined variance as the data element the greatest determined impact.

31. The computer-implemented method of claim 30, wherein:
the relating step comprises relating the plurality of data elements to a plurality of different predetermined key performance measures
the relationship specification defines the mathematical relationship between the plurality of data elements and the plurality of key performance measures; and
the calculating step comprises calculating a value for each of the plurality of key performance measures and a variance in each of the determined values over the time period.

32. The computer-implemented method of claim 30, wherein the relationship specification defines a hierarchical mathematical relationship between a plurality of different key performance measures.

33. The computer-implemented method of claim 31, wherein the relationship specification defines a hierarchical mathematical relationship between a plurality of different key performance measures and intermediate performance measures.

34. The computer-implemented method of claim 30, wherein at least some of the data elements comprise intermediate performance measures.

35. The computer-implemented method of claim 30, wherein the determining step comprises calculating the contribution value of each data element by changing the value of the data element, and holding all other data elements constant for each determined variance.

36. The computer-implemented method of claim 30, wherein the identifying step comprises identifying a plurality of the data elements which provide the most significant impact on the determined variance.

37. The computer-implemented method of claim 30, wherein the receiving step comprises receiving data elements from an analytics system for analysing the operation of the complex entity.

38. The computer-implemented method of claim 30, wherein the complex entity is an enterprise and the receiving step comprises receiving the data elements from a computer system of the enterprise.

39. The computer-implemented method of claim 38, wherein the enterprise comprises an e-commerce enterprise.

40. The computer-implemented method of claim 30, wherein the performance measure is related to a specific section of the complex entity.

41. The computer-implemented method of claim 40, wherein the complex entity is an enterprise, the receiving step comprises receiving the data elements from a computer system of the enterprise and the specific section of the complex entity comprises an enterprise category.

42. The computer-implemented method of claim 40, wherein the calculation step comprises calculating the value of the performance measure from a subset of the received data elements, the subset relating to the specific section of the complex entity; and
the determining step comprises determining the impact of each of the data elements of the subset on the determined variance, by calculating a contribution value of each data element of the subset.

43. The computer-implemented method of claim 41, wherein the calculation step comprises selecting the subset of received data elements which relate to the same specific section of the complex entity as the performance measure.

44. The computer-implemented method of claim 30, wherein at least some of the plurality of data elements comprise an intermediate performance measure or the method further comprises creating an intermediate performance measure using the plurality of data elements and the relationship specification.

45. The computer-implemented method of claim 43, further comprising:
storing an action specification, the action specification relating different combinations of data elements and/or intermediate performance measures and different thresholds for the value of the data elements and/or the intermediate performance measures to one or more different actions; and
determining one or more different actions to be taken as a consequence of calculating a significant variance in the key performance measure, the determining step comprises determining the resultant action by use of the action specification and the values of the data elements and/or the intermediate performance measures identified as the source of the significant variance.

46. The computer-implemented method of claim 45, wherein the action determining step comprises determining one or more different actions to be taken as a consequence of calculating the most significant variance in the key performance measure of a specific section of the complex entity, from a subset of the received data elements and/or the intermediate performance measures identified as the source of the significant variance which relate to that specific section of the complex entity.

47. The computer-implemented method of claim 45, further comprising
calculating, using the relationship specification and the action specification, an action impact value for each different action determined by the action determining step, the action impact value providing a measure of the estimated impact of an action on the performance measure.

48. The computer-implemented method of claim 47, further comprising:
determining the rank of each action determined by the action determining step, the rank determining step comprises using the associated impact value calculated by the action impact value calculating step.

49. The computer-implemented method of claim 48, further comprising:
providing a graphical user interface (GUI) at a user terminal; and
displaying in a graphical user interface graphical representations of the one or more actions determined by the action rule determining step, the displaying step comprising positioning the representations of the one or more actions in the GUI according to the determined ranking.

50. The computer-implemented method of claim 49, wherein the displaying step comprises: displaying in the GUI graphical representations of the one or more actions determined by the action rule determining step for a subset of the received data elements that relates to a specific section of the complex entity.

51. The computer-implemented method of claim 50, wherein the GUI controller is arranged to filter the one or more actions to display on the basis of a user-selected specific section of the complex entity.

52. The computer-implemented method of claim 50, wherein the GUI controller is arranged to display in the GUI the one or more data elements that have been determined by the impact identification step as being the most significant source of the determined variance.

53. The computer-implemented method of claim 52, wherein the GUI controller is arranged to filter the one or more data elements to display on the basis of a user-selected specific section of the complex entity.

54. The computer-implemented method of claim 30, wherein the performance measure is the complex entity's trading profit.

55. The computer-implemented method of claim 30, wherein the variance in the performance measure value is indicative of a decrease in the complex entity's performance over the time period.

56. The computer-implemented method of claim 30, wherein the receiving step comprises receiving the plurality of data elements from a plurality of different entities via a shared communications channel, the plurality of received data elements being associated with the plurality of different entities.

57. The computer-implemented method of claim 30, wherein:
the receiving step comprises receiving the plurality of data elements in real-time;
the calculating step comprises calculating the key performance measure value in real-time;
the determining step comprises determining the impact of each data element on the determined variance, by calculating the contribution value of each data element in real-time; and
the identifying step comprises identifying the most significant source of the variance in real-time.

58. The computer-implemented method of claim 45, further comprising simulating the effect that implementing any one of the actions determined by the action determining step the will have on the key performance measure.

59. A computer server configured to carry out the method of claim 30.

60. A computer program product, comprising computer executable source code arranged to execute the method of claim 30.

61. A computer system for determining a significant source of variance in a performance measure of a complex entity during a time period, the system comprising:
a data processing module arranged to receive a plurality of data elements and to relate the plurality of data elements to a plurality of predetermined key performance measures;
a data storage device storing:
a relationship specification defining the relationship between the plurality of data elements and the plurality of key performance measures,
an action specification, the action specification relating different combinations of data elements and different thresholds for the value of the data elements to one or more different actions;
a performance measure calculation module arranged to calculate values of the key performance measures from the received data elements using the relationship specification and hence a variance in each of the determined values over the time period;
an impact identification module arranged to determine the impact of each data element on the determined variance, by calculating a contribution value of each data element for the determined variance and identifying the most significant source of the determined variance as the data element with the greatest determined impact; and
an action rule module arranged to determine one or more different actions to be taken as a consequence of calculating a significant variance in the key performance measure, the action rule module determining the resultant action by use of the values of the data elements identified as the source of the significant variance and the action specification.

62. A computer system for determining a significant source of variance in a performance measure of a complex entity during a time period, the system comprising:
a data processing module arranged to receive a plurality of data elements and to relate the plurality of data elements to a plurality of predetermined key performance measures;
a data storage device storing:
a relationship specification defining the relationship between the plurality of data elements and the plurality of key performance measures,
an action specification, the action specification relating different combinations of data elements and different thresholds for the value of the data elements to one or more different actions;
a performance measure calculation module arranged to calculate values of the key performance measures from the received data elements using the relationship specification and hence a variance in each of the determined values over the time period;
an impact identification module arranged to determine the impact of each data element on the determined variance, by calculating a contribution value of each data element for the determined variance and identifying the most significant source of the determined variance as the data element with the greatest determined impact;
an action rule module arranged to determine one or more different actions to be taken as a consequence of calculating a significant variance in the key performance measure, the action rule module determining the resultant action by use of the values of the data elements identified as the source of the significant variance and the action specification;
an action impact value calculator module arranged to calculate, using the relationship specification and the action specification, an impact value for each different action determined by the action rule module, the impact value providing a measure of the estimated impact of an action on the performance measure;
an action ranking module arranged to determine the rank of each action determined by the action rule module, using the associated impact value calculated by the action impact value calculator module;
a user terminal; and
a graphical user interface controller arranged to display in a graphical user interface on the user terminal, the one or more actions determined by the action rule module, the controller displaying the one or more actions according to the rank of the action determined by the action ranking module.
